(19) United States
(12) Patent Application Publication
(10) Pub. No.: US 2026/0191735 A1
(43) Pub. Date: Jul. 9, 2026

(54) SYSTEM, APPARATUS, AND METHOD FOR PROVIDING A SEXUAL STIMULATION DEVICE

(71) Applicant: HYTTO PTE. LTD, Singapore (SG)

(72) Inventor: Peisen Wu, Guangdong (CN)

(21) Appl. No.: 19/555,156

(22) Filed: Mar. 3, 2026

Related U.S. Application Data
(63) Continuation-in-part of application No. 18/499,094, filed on Oct. 31, 2023.

(30) Foreign Application Priority Data
Jul. 31, 2025 (CN) 202521620175.2

(51) Int. Cl. A61H 19/00; A61H 23/00

(52) U.S. Cl. CPC A61H 19/40; A61H 19/34; A61H 23/006; A61H 2201/0153; A61H 2201/0207; A61H 2201/0214; A61H 2201/10

(57) ABSTRACT

A sexual stimulation device is disclosed. The sexual stimulation device has a main body having a plurality of configurations, and a hand-held portion. The main body includes a first stimulating member, adapted to be inserted into an orifice of a human body; and a second stimulating member having a second stimulating end. The main body is continuously deformable in response to a first gesture operation performed by a user on the hand-held portion, such that the first gesture operation causes the main body to transition from a first configuration within a first range of the plurality of configurations along a continuous deformation path to a second configuration within a second range of the plurality of configurations along the continuous deformation path.

### CROSS-REFERENCE TO RELATED APPLICATIONS

This application claims priority to Chinese Patent Application No. 202521620175.2 filed on July 31, 2025. This application is also a Continuation-in-Part of co-pending U.S. patent application No. 18/499,094, filed on Oct. 31, 2023, the entire contents of which are herein incorporated by reference.

### FIELD OF THE INVENTION

The present disclosure generally relates to a system, apparatus, and method for providing a device, and more particularly to a system, apparatus, and method for providing a sexual stimulation device.

### BACKGROUND OF THE INVENTION

Sexual stimulation devices that induce sexual pleasure through self-stimulation by a user are well known and have been commercially available for several decades. For example, vibrators, including those having a shaft resembling a penis, as well as G-spot stimulators, are known and are used by women for the purpose of providing self-stimulation. Conventional G-spot stimulators generally have a shape similar to that of a standard vibrator in that they include a shaft resembling a penis, but differ from standard vibrators in that they additionally include a curved or flared terminal end designed specifically for stimulating the G-spot.

Although debate continues regarding the existence and unique structure of the G-spot (Grafenberg spot), G-spot stimulators continue to occupy an important position in the market for sexual stimulation devices. These devices are designed to massage the G-spot, which many women describe as an erogenous zone located on the anterior wall of the vagina, about one to three inches from the vaginal opening, and highly sensitive to sexual stimulation. Accordingly, G-spot stimulators typically include a region configured to directly stimulate the G-spot.

Combination vibrators have also been developed to stimulate both the vagina (e.g., the G-spot) and the clitoris or clitoral region (sometimes referred to as the C-spot) at the same time. A well-known example of a combination vibrator is the “rabbit vibrator” (the name “rabbit” being derived from the shape of the C-spot stimulator, which often resembles an animal figure such as a rabbit, dolphin, or butterfly). The rabbit vibrator typically includes a shaft portion terminating in a hook-shaped or flared end for G-spot stimulation, and a C-spot stimulator located near the base of the shaft. Other rabbit-type vibrators may include a finger- or thumb-shaped attachment serving as the C-spot stimulator.

However, existing stimulation devices such as combination vibrators are typically cumbersome to easily adjust and manipulate. For example, use of such combination vibrators often involves two-handed adjustment and manipulation to provide desired stimulation effects.

Accordingly, a need in the art exists for alternative internal-and-external combination sexual stimulation devices that can provide improved and varied stimulation effects.

The exemplary disclosed system, apparatus, and method are directed to overcoming one or more of the shortcomings set forth above and/or other deficiencies in existing technology.

### SUMMARY OF THE INVENTION

In one exemplary aspect, the present disclosure is directed to a sexual stimulation device. The sexual stimulation device includes a main body having a plurality of configurations, and a hand-held portion. The main body includes a first stimulating member, adapted to be inserted into an orifice of a human body; and a second stimulating member having a second stimulating end. The main body is continuously deformable in response to a first gesture operation performed by a user on the hand-held portion, such that the first gesture operation causes the main body to transition from a first configuration within a first range of the plurality of configurations along a continuous deformation path to a second configuration within a second range of the plurality of configurations along the continuous deformation path. In the first range of the plurality of configurations along the continuous deformation path, the first stimulating member and the second stimulating end are both adapted to be inserted into or out of the orifice, which is the same orifice, of the human body. In the second range of the plurality of configurations along the continuous deformation path, the first stimulating member is adapted to be inserted into or out of the orifice while the second stimulating end is adapted to remain outside of the orifice and in continuous contact with a first erogenous region adjacent to the orifice.

In another aspect, the present disclosure is directed to a method. The method includes operating a sexual stimulation device including a main body and a hand-held portion, the main body including a first stimulating member and a second stimulating member having a second stimulating end; and performing a gesture operation on the hand-held portion to continuously deform the main body along a continuous deformation path, such that the main body transitions between different configurations along the continuous deformation path. In a first range of the configurations along the continuous deformation path, the method further comprises inserting both the first stimulating member and the second stimulating end into or out of an orifice, which is the same orifice, of a human body. In a second range of the configurations along the continuous deformation path, the method further comprises inserting the first stimulating member into or out of the orifice while maintaining the second stimulating end outside of the orifice and in continuous contact with a first erogenous region adjacent to the orifice. The transition between the first range and the second range is effected by the gesture operation being performed on the hand-held portion while the first stimulating member moves into or out of the orifice.

### BRIEF DESCRIPTION OF THE DRAWINGS

FIG. 1 is a schematic illustration of an exemplary system of the present invention;

FIG. 2 is schematic illustration of exemplary accessories of the exemplary disclosed system;

FIG. 3 is a schematic illustration of an exemplary embodiment of the exemplary disclosed system;

FIG. 4 is a schematic illustration of an exemplary embodiment of the exemplary disclosed system;

FIG. 5 is a schematic illustration of an exemplary embodiment of the exemplary disclosed system;

FIG. 6 is a side illustration of an exemplary embodiment of the exemplary disclosed system;

FIG. 7 is a perspective illustration of the exemplary embodiment illustrated in FIG. 6 of the exemplary disclosed system;

FIG. 8 is another side illustration of the exemplary embodiment illustrated in FIG. 6 of the exemplary disclosed system;

FIG. 9 is another perspective illustration of the exemplary embodiment illustrated in FIG. 6 of the exemplary disclosed system;

FIG. 10 is another side illustration of the exemplary embodiment illustrated in FIG. 6 of the exemplary disclosed system;

FIG. 11 is another perspective illustration of the exemplary embodiment illustrated in FIG. 6 of the exemplary disclosed system;

FIG. 12 is a perspective illustration of another exemplary embodiment of the exemplary disclosed system;

FIG. 13 is a perspective illustration of another exemplary embodiment of the exemplary disclosed system;

FIG. 14 is a side illustration of another exemplary embodiment of the exemplary disclosed system;

FIG. 15 is another side illustration of the exemplary embodiment illustrated in FIG. 14 of the exemplary disclosed system;

FIG. 16 is another side illustration of the exemplary embodiment illustrated in FIG. 14 of the exemplary disclosed system;

FIG. 16A is a side illustration of another exemplary embodiment of the exemplary disclosed system;

FIG. 17 is a flowchart showing an exemplary process of the present invention;

FIGS. 18A and 18B are schematic illustrations showing a use of the exemplary disclosed system;

FIG. 19 is a perspective illustration of another exemplary embodiment of the exemplary disclosed system;

FIGS. 20A, 20B, 20C, and 20D are schematic illustrations showing uses of the exemplary disclosed system;

FIG. 21 is a schematic illustration of an exemplary computing device, in accordance with at least some exemplary embodiments of the present disclosure; and

FIG. 22 is a schematic illustration of an exemplary network, in accordance with at least some exemplary embodiments of the present disclosure.

### DETAILED DESCRIPTION AND INDUSTRIAL APPLICABILITY

In at least some exemplary embodiments, an adult toy such as a sexual stimulation device is disclosed. The exemplary disclosed interactive sexual device may for example be used with system 300 described below. The exemplary disclosed sexual stimulation device may be a combination vibrator that may provide multiple distinct stimulation modes. For example, the exemplary disclosed sexual stimulation device may provide for structural and configurational transformations based on efficient and effective operation (e.g., thereby providing a convenient user operation).

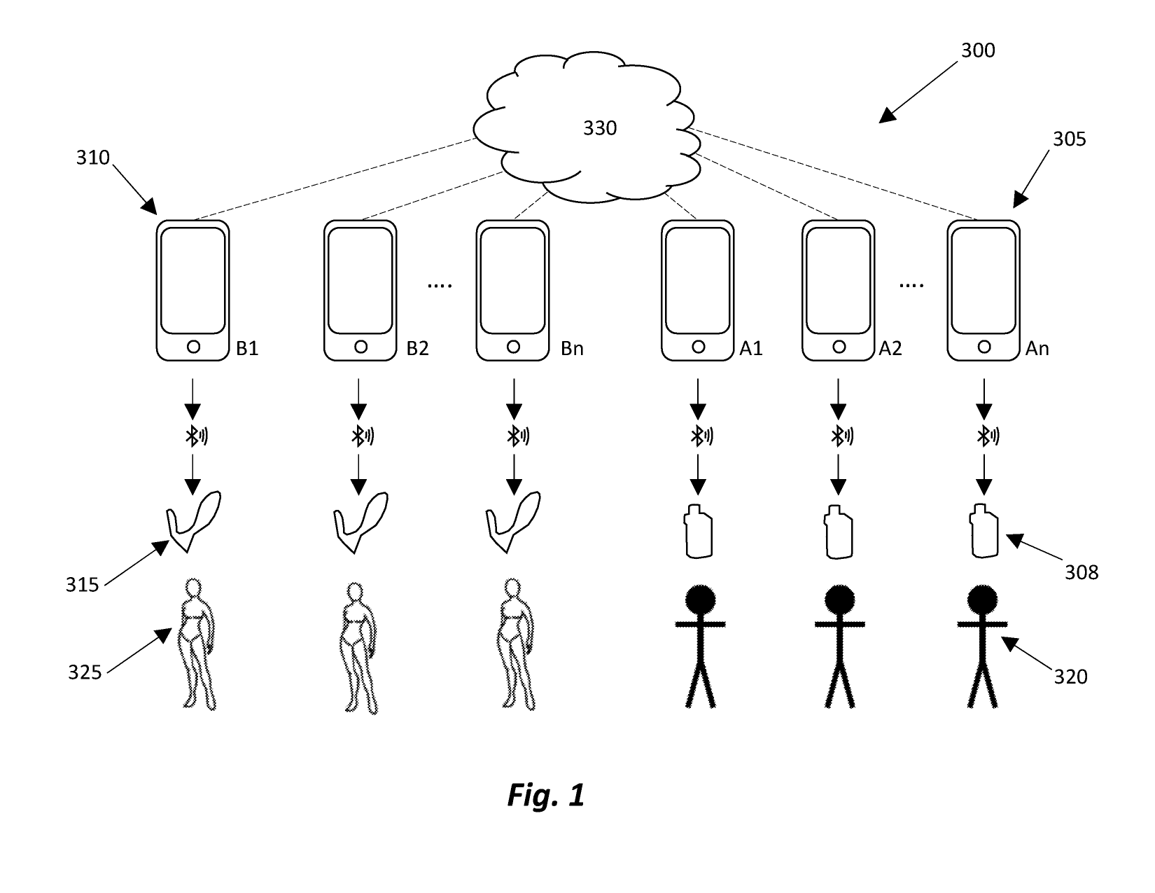

As illustrated in FIG. 1, system 300 may include one or more male user devices 305, one or more female user devices 310, one or more male accessories 308, and/or one or more female accessories 315. For example, system 300 may include a plurality of male user devices 305, a plurality of male accessories 308, a plurality of female user devices 310, and a plurality of female accessories 315. Data such as image data, audio data, and/or control data may be transferred between male user devices 305, male accessories 308, female user devices 310, and female accessories 315.

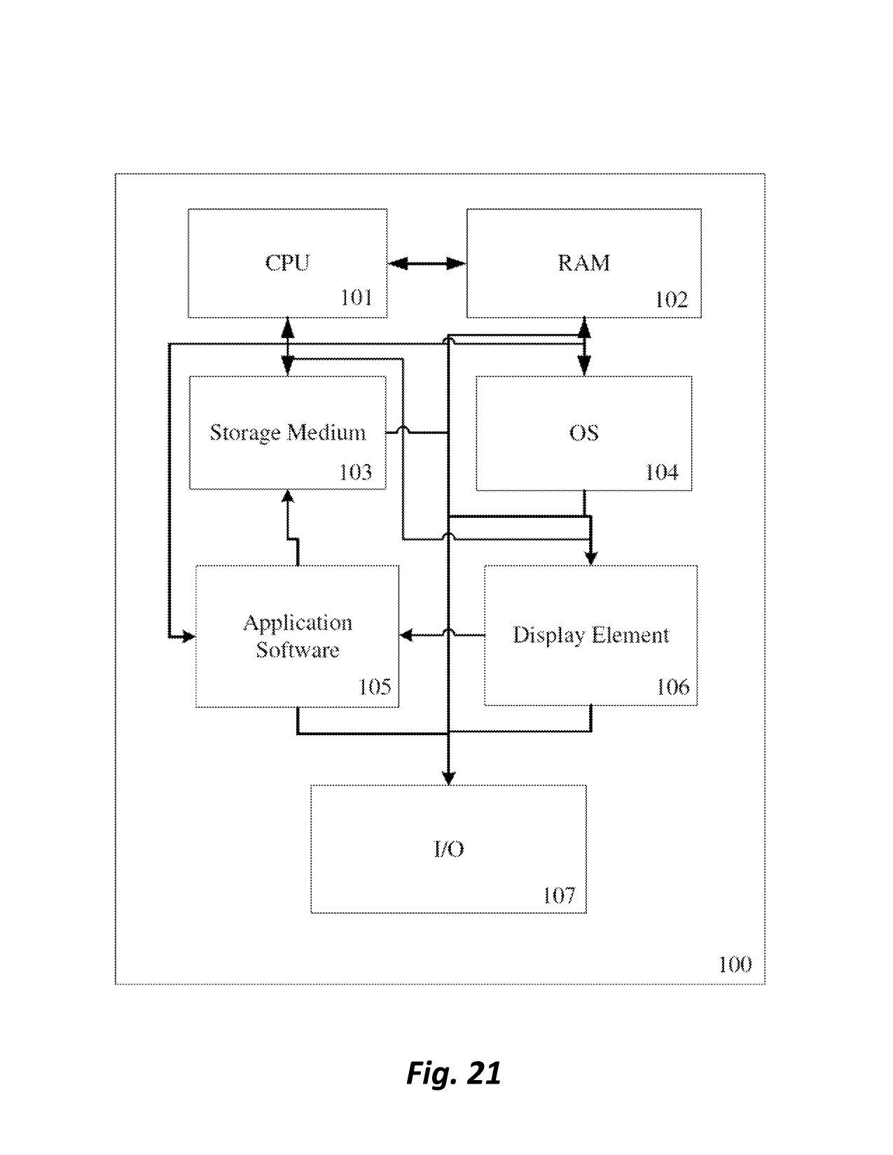

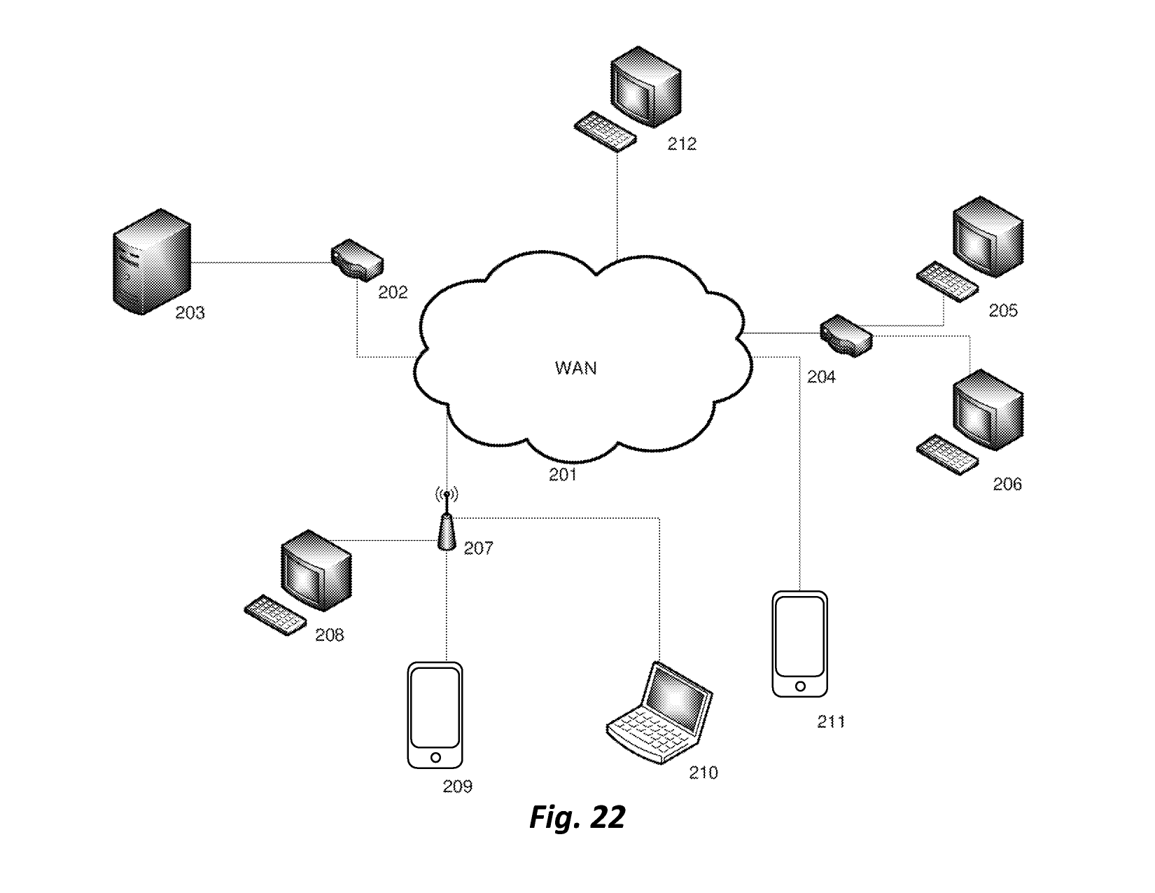

Returning to FIG. 1, system 300 may include any desired number of male user devices 305 (e.g., A1, A2, … An). Male user device 305 may be any suitable device for interfacing with other components of system 300 such as a computing device (e.g., user interface). For example, male user device 305 may be any suitable user interface for receiving input and/or providing output (e.g., image data) to a male user 320. Male user device 305 may include a camera and a microphone. Male user device 305 may be, for example, a touchscreen device (e.g., of a smartphone, a tablet, a smartboard, and/or any suitable computer device), a wearable device, a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 21 and 22). For example, male user device 305 may include a touchscreen device of a smartphone or handheld tablet. For example, male user device 305 may include a display (e.g., a computing device display, a touchscreen display, and/or any other suitable type of display) that may provide output, image data, and/or any other desired output or input prompt to a user. For example, the exemplary display may include a graphical user interface to facilitate entry of input by a user and/or receiving output such as image data. An application for example as described herein and/or a web browser may be installed on male user device 305 and utilized by male user 320.

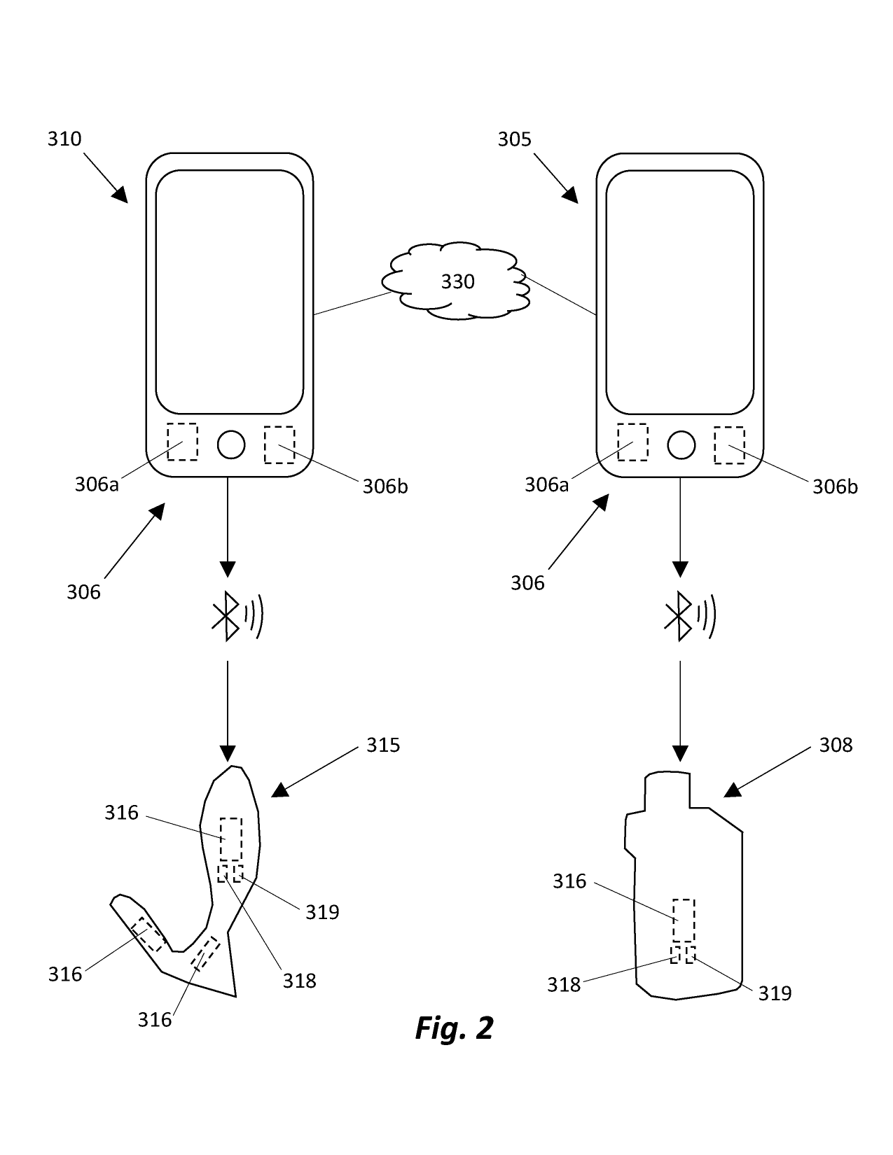

As illustrated in FIG. 2, male user device 305 may include a sensor array 306. In at least some exemplary embodiments, sensor array 306 may include one or more sensors integrated or built into the exemplary disclosed user device (e.g., male user device 305) such as, for example, a mobile phone, a pad, or a wearable device. Sensor array 306 may include any suitable sensors for use with system 300 such as, for example, a location sensor 306a and a movement sensor 306b. Location sensor 306a may include a GPS device, a Galileo device, a GLONASS device, an IRNSS device, a BeiDou device, and/or any other suitable device that may operate with a global navigation system.

Movement sensor 306b may include any suitable components for sensing motion (e.g., motion amplitude), velocity, and/or acceleration. Movement sensor 306b may include an acceleration sensor. Movement sensor 306b may include a gyroscope. For example, movement sensor 306b may include a displacement sensor, a velocity sensor, and/or an accelerometer. For example, movement sensor 306b may include components such as a servo accelerometer, a piezoelectric accelerometer, a potentiometric accelerometer, and/or a strain gauge accelerometer. Movement sensor 306b may include a piezoelectric velocity sensor or any other suitable type of velocity or acceleration sensor.

System 300 may include any desired number of female user devices 310 (e.g., B1, B2, … Bn). Female user device 310 may be similar to male user device 305. For example, female user device 310 may be any suitable user interface for receiving input and/or providing output (e.g., image data) to a female user 325. Female user 325 may operate female user device 310 to record and transfer image (e.g., video) and audio data to one or more male users 320 and/or other female users 325 via a network 330. Additional exemplary disclosed devices and/or users of any desired gender may also be included in the exemplary disclosed system (e.g., a non-binary user and/or a non-binary user device and/or non-binary accessory similar to the examples described herein).

Female accessory 315 may be any suitable accessory for use by female user 325 (e.g., when female user 325 is imaged by female user device 310). For example, female accessory 315 may be a prop that is used by female user 325 while female user 325 is being imaged (e.g., a video or pictures of female user 325 are being recorded and/or transmitted in real-time to be viewed by male user 320 and/or another female user 325). For example, female accessory 315 may be a device used for erotic stimulation (e.g., a sex aid or a “sex toy”). Female accessory 315 may be a sexual stimulation device that may be associated with a given female user 325 and respective female user device 310 of that given female user 325. In at least some exemplary embodiments, female accessory 315 may be a massaging apparatus for human genitalia (e.g., a vibrator). For example, female accessory 315 may be any suitable device for use in a video or pictures recorded by female user device 310, which may be an erotic video or erotic pictures). In at least some exemplary embodiments, female accessory 315 may be a tool or other indicator that may be used in video or pictures recorded by female user device 310 such as a sign providing information such as location or time information, a surveillance tool used by female user 325, and/or any other suitable tool or accessory that may be used while female user device 310 is recording a video or pictures of female user 325. For example, female user 325 may be an erotic model using female accessory 315 that may be an erotic device, a technician or laborer using female accessory 315 that may be a tool or work device specific to a desired application, and/or any other desired role using any suitable female accessory 315.

Female accessory 315 may include one or more actuator mechanisms, for example, driving components such as one or more motors 316. Motor 316 may include an electric motor. Motor 316 may include a servomotor, a stepper motor, a brushless motor, or any other suitable type of motor. Motor 316 may include any suitable vibration motor or haptic motor such as, for example, a mini vibrator motor. Motor 316 may include a low voltage motor. Motor 316 may include a pager motor or a coin vibration motor. Motor 316 may include a linear resonant actuator or an eccentric rotating mass vibration motor. Motor 316 may be a reversible electric motor (e.g., a reversible electric motor). Motor 316 may be a unidirectional motor (e.g., a one-way motor). Motor 316 may be powered by any suitable power source, such as a battery (e.g., a nickel-metal hydride battery, a lithium-ion battery, an ultracapacitor battery, a lead-acid battery, and/or a nickel cadmium battery), an electric power source (e.g., a transformer connected to a plug that may plug into an outlet), and/or any other suitable energy source. Female accessory 315 may include a controller 319 that may be any suitable computing device for controlling an operation of motor 316 and a communication device 318. Controller 319 may, for example, include components similar to the components described below regarding FIG. 21. Controller 319 may include for example a processor (e.g., micro-processing logic control device) or board components. Controller 319 may control one or more motors 316 based on input data and/or commands (e.g., control commands) received from male user device 305 and/or female user device 310 via a network 330 and/or communication device 318 (e.g., transferred directly to communication device 318 by any suitable component of system 300). Motor 316 may be controlled by controller 319 to vibrate female accessory 315 at a desired level or strength, perform a suction operation at a desired level or strength using female accessory 315 (e.g., using female accessory 315 as a suction device), rotate or swing female accessory 315 at a desired speed or amount, contract or expand female accessory 315 by a desired amount, cause female accessory 315 to perform an inhalation action, and/or cause female accessory 315 to perform any other suitable action or function.

In at least some exemplary embodiments, the exemplary disclosed actuator mechanism may be or may include a thermal device such as a heater (e.g., or a cooler or any other suitable thermal device). Alternatively for example, a heater unit and the exemplary disclosed motor may be separately provided (e.g., installed) in the exemplary disclosed adult toy. In at least some exemplary embodiments, the exemplary disclosed actuator mechanism may include an electric heating device such as an electric resistance heating device. The exemplary disclosed actuator mechanism may include a polyimide heater, a silicone rubber heater, and/or a resistive wire heater. The exemplary disclosed actuator mechanism may be controlled by controller 319 to heat or emit heat or warmth from female accessory 315. For example, the exemplary disclosed actuator mechanism may cause a temperature variation of female accessory 315.

Returning to FIG. 2, male accessory 308 may include components generally similar to female accessory 315 and may operate generally similarly to female accessory 315. Male accessory 308 may be a sexual stimulation device that may be associated with a given male user 320 (e.g., a viewer of one or more female users 325 and/or male users 320; or a male model) and respective male user device 305 (e.g., a viewer device) of that given male user 320.

Network 330 may be any suitable communication network over which data may be transferred between one or more male user devices 305, one or more male accessories 308, one or more female user devices 310, and/or one or more female accessories 315. Network 330 may be the internet, a LAN (e.g., via Ethernet LAN), a WAN, a WiFi network, or any other suitable network. Network 330 may be similar to WAN 201 described below. The components of system 300 may also be directly connected (e.g., by wire, cable, USB connection, and/or any other suitable electro-mechanical connection) to each other and/or connected via network 330. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 22. Male user devices 305, male accessories 308, female user devices 310, and/or female accessories 315 may include any suitable communication components for communicating with other components of system 300 using for example the communication techniques described above. For example, male user devices 305 and female user devices 310 may include integrally formed communication devices (e.g., smartphone components), and male accessories 308 and female accessories 315 may each include communication device 318 that may communicate using any of the exemplary disclosed communication techniques.

In at least some exemplary embodiments, a given female accessory 315 may communicate with a given female user device 310 (e.g., a paired female user device 310) via any suitable short distance communication technique. For example, female accessories 315 (e.g., via communication device 318) and female user devices 310 may communicate via WiFi, Bluetooth, ZigBee, NFC, IrDA, and/or any other suitable short distance technique. Female accessory 315 may be an adult toy that may be connected with female user device 310 through short distance wireless communication. An application (e.g., operating using the exemplary disclosed modules) may be installed on female user device 310, the application and female user device 310 being configured to send commands to female accessory 315 to drive (e.g., actuate) female accessory 315. Male accessory 308 may communicate with male user device 305 similarly to the communication of female accessory 315 and female user device 310 described above.

System 300 may include one or modules for performing the exemplary disclosed operations such as, for example, the exemplary disclosed modules for example as described herein. The one or more modules may include an accessory control module for controlling male accessory 308 and female accessory 315. The one or more modules may be stored and operated by any suitable components of system 300 (e.g., including processor components) such as, for example, network 330, male user device 305, male accessory 308, female user device 310, female accessory 315, and/or any other suitable component of system 300. For example, system 300 may include one or more modules having computer-executable code stored in non-volatile memory. System 300 may also include one or more storages (e.g., buffer storages) that may include components similar to the exemplary disclosed computing device and network components described below regarding FIGS. 21 and 22. For example, the exemplary disclosed buffer storage may include components similar to the exemplary storage medium and RAM described below regarding FIG. 21. The exemplary disclosed buffer storage may be implemented in software and/or a fixed memory location in hardware of system 300. The exemplary disclosed buffer storage (e.g., a data buffer) may store data temporarily during an operation of system 300.

The one or more exemplary disclosed modules may include software modules running on model equipment. The software modules may include a smart panel (e.g., as described below), game plug-ins, and/or toy control plug-ins (e.g., for the exemplary disclosed toys) that may assist models in live broadcasting.

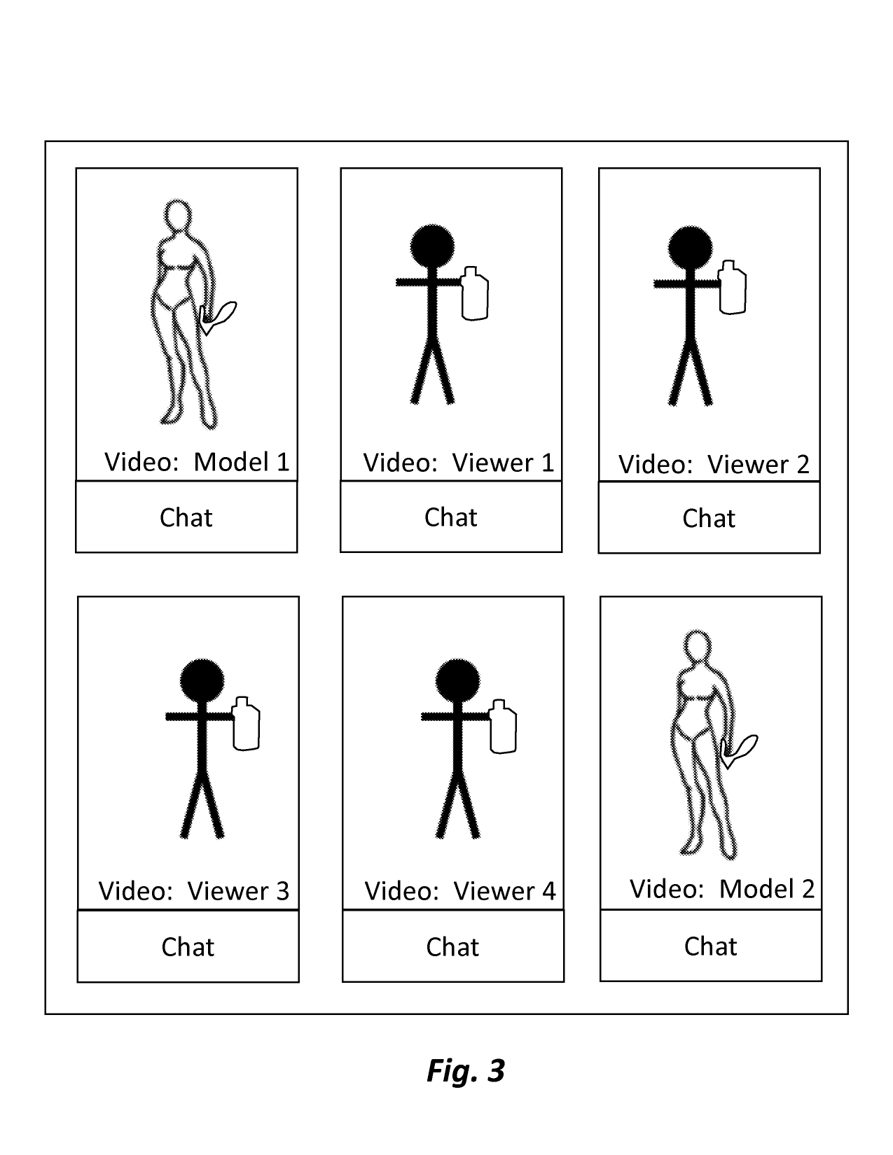

The one or more exemplary disclosed modules may also provide a chat room interface via one or more male user devices 305 and/or one or more female user devices 310 for use by male users 320 and female users 325. For example, a video display of female user 325, a video display of one or more male users 320, and/or and a graphical display of a chat or messaging app (e.g., any suitable chat communication or messaging app such as, for example, text, voice, and/or video chat boxes) may be displayed to each male user 320 via male user device 305 and to each female user 325 via female user device 310. One or more male users 320 and one or more female users 325 may thereby view and chat (e.g., text, voice, and/or video chat) with each other via the one or more exemplary disclosed modules via respective male user devices 305 and female user devices 310. Male users 320 and female users 325 may thereby view, interact with, and/or chat (e.g., text, voice, and/or video chat) with other female users 325 and/or other male users 320 (e.g., and/or any other users of an gender such as non-binary users as described above or any other gender). For example, multiple text, voice, and/or video chat boxes including a plurality of male users 320 (e.g., viewers or models each having one or more male accessories 308) and/or a plurality of female users 325 (e.g., viewers or models each having one or more female accessories 315) may be displayed to each male user 320 and each female user 325 via respective male user devices 305 and female user devices 310. Male users 320 and female users 325 may thereby view and interact with other male users 320 and female users 325 that may each have one or more respective accessories (e.g., respective male accessories 308 and female accessories 315). FIG. 3 schematically illustrates an exemplary embodiment of the exemplary disclosed chat room that may be displayed to male user 320 via male user device 305 and/or to female user 325 via female user device 310.

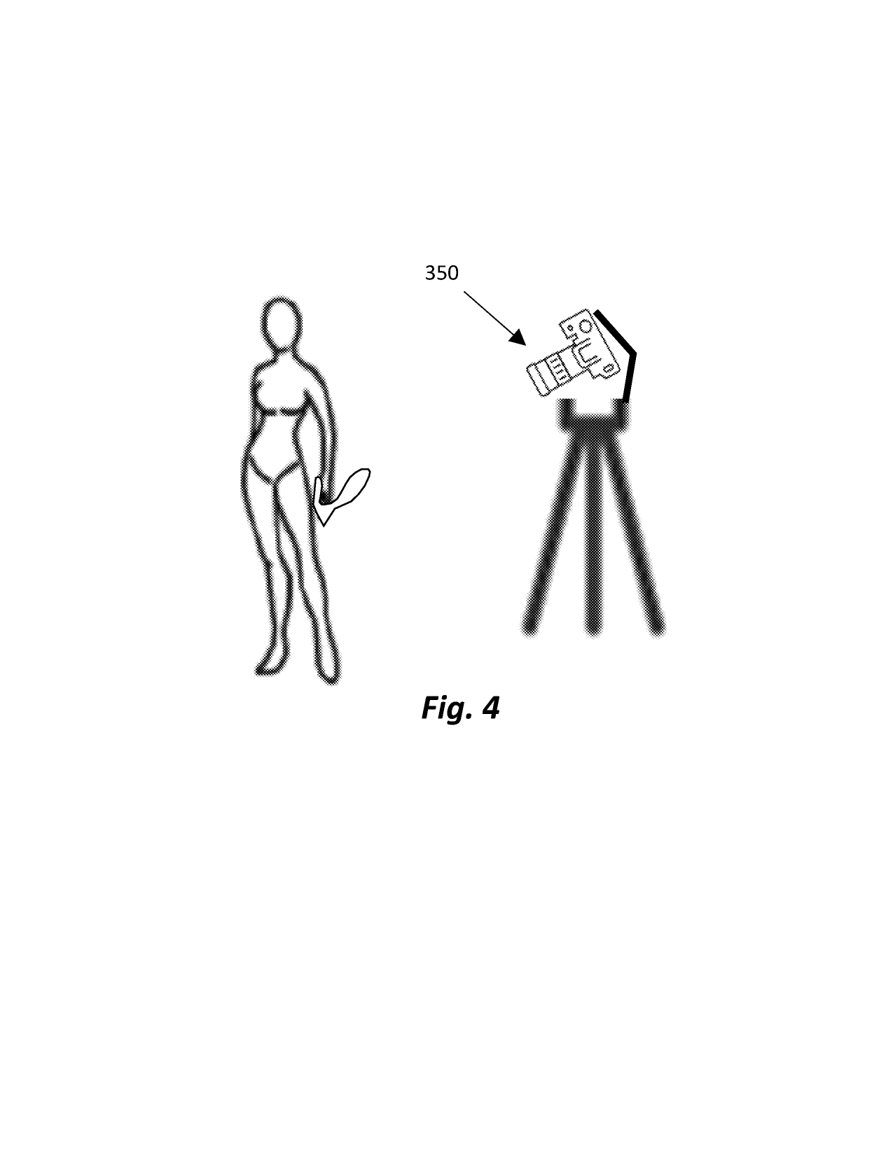

In at least some exemplary embodiments and as illustrated in FIG. 4, system 300 may further include an imaging device 350. Imaging device 350 may be used directly and/or indirectly to provide data to be used in an operation of system 300. For example, imaging device 350 may be a camera that may be used to obtain user input (e.g., data of gesturing images made by the user) by any suitable imaging technique (e.g., for example as described herein).

Imaging device 350 may be any suitable imaging device such as a camera. For example, imaging device 350 may be any suitable video camera such as a digital video camera, a webcam, and/or any other suitable camera for recording visual data (e.g., recording a video or taking pictures) and/or image recognition. Imaging device 350 may be a 3D camera. Imaging device 350 may be a headset that may be worn by a user (e.g., male user 320 or female user 325). Imaging device 350 may be a spatial computing device (e.g., a spatial computer). Imaging device 350 may utilize any suitable spatial computing features and/or techniques (e.g., similar to Apple Vision Pro). Imaging device 350 may be for example a three-dimensional video sensor or camera. One or more imaging devices 350 may include a plurality of cameras or a single camera configured to collect three-dimensional image data. In at least some exemplary embodiments, imaging device 350 may be a stereoscopic camera and/or any other suitable device for stereo photography, stereo videography, and/or stereoscopic vision. Imaging device 350 may be substantially entirely integrated into the exemplary disclosed user devices or may be a stand-alone device. In at least some exemplary embodiments, imaging device 350 may be a smartphone or tablet camera. Imaging device 350 may provide data to an exemplary image recognition module of system 300. Imaging device 350 may include one or more actuators that may adjust a position of imaging device 350 based on an operation of system 300 (imaging device 350 may also include a support or stand for supporting imaging device 350). The actuators may be for example one or more external actuators disposed at an exterior of imaging device 350 and/or one or more integrated actuators that are completely or partially integrated into imaging device 350 (e.g., disposed and/or integrated within an interior of imaging device 350). In at least some exemplary embodiments, the actuators may be internally integrated into imaging device 350 and may turn optical components and/or move lenses of imaging device 350 within a housing of imaging device 350 to zoom in and out at different features or points within a variable field of view of imaging device 350 (e.g., zoom in and out on points or features of a user and/or exemplary disclosed accessories). The actuator may also be one or more external and/or internally-integrated mechanical actuators configured to mechanically turn imaging device 350 and move lenses of imaging device 350 to focus in and out at desired objects (e.g., points and/or features of a user and/or an accessory). System 300 may also include an image recognition module that may perform feature detection and matching to allow for matching and comparison of features imaged by imaging device 350. For example, imaging device 350 may find predetermined features that may correspond to two-dimensional and/or three-dimensional surfaces and/or contours of an object within a field of view of imaging device 350. Also for example, any suitable technique may be used to identify features (e.g., spatial data) of a viewed object (e.g., features of a user and/or accessory) and to match those imaged features to predetermined features provided by system 300 (e.g., or provided by a user). Also for example, optical character recognition of text and/or markings located on a viewed object may be performed. For example, spatial data and/or other data may be determined that may be matched to predetermined data provided by system 300 (e.g., predetermined shapes, colors, text, contours, and other features). For example, the spatial data and/or other data may include data defining points (e.g., or contours) of a user and/or accessory based on an actual image of an object (e.g., the exemplary disclosed accessories) imaged by imaging device 350. For example, spatial and/or data based on viewing an object may be used to match that data to predetermined data to identify points or features of an object being viewed. Any suitable techniques for recognizing objects and/or determining spatial and/or other data of a viewed object may be utilized by system 300 for image recognition via imaging device 350.

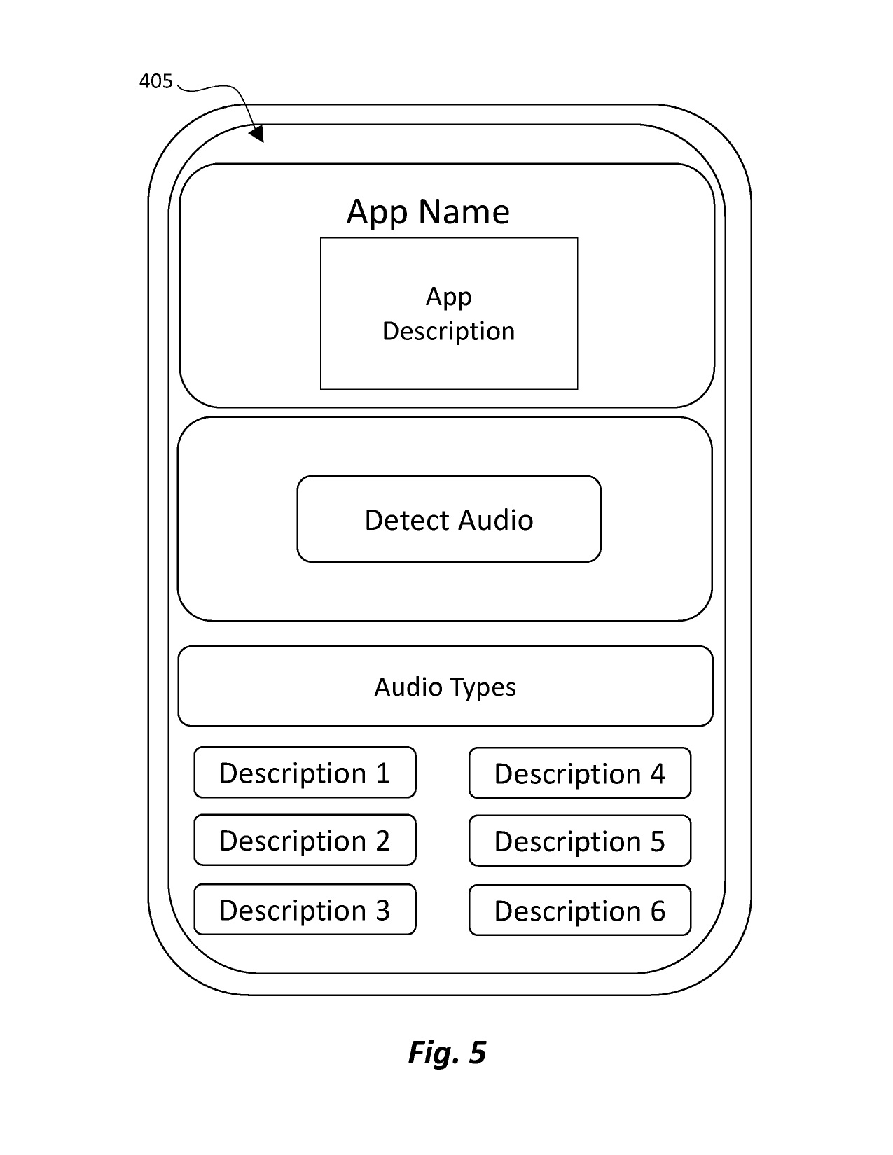

In at least some exemplary embodiments and for example as illustrated in FIG. 5, graphical elements provided by system 300 may be displayed on a graphical user interface such as a GUI 405 on a display or touchscreen of the exemplary disclosed user device (e.g., male user device 305, female user device 310, and/or any other suitable user device) to the user (e.g., or a spatial computing interface such as for example similar to Apple Vision Pro). Any suitable graphical element (e.g., text, graphics, GIFs, video, and/or any other suitable graphics) may be displayed on GUI 405. GUI 405 may display the exemplary disclosed live broadcast and/or data and/or elements associated with the live broadcast (e.g., input data, output data, control elements, graphical elements, information, and/or any other suitable data and/or objects) to one or more viewers and/or models (e.g., one or more female users 325 and/or male users 320) via one or more exemplary disclosed user devices (e.g., one or more female user devices 310 and/or one or more male user devices 305, and/or any other suitable device).

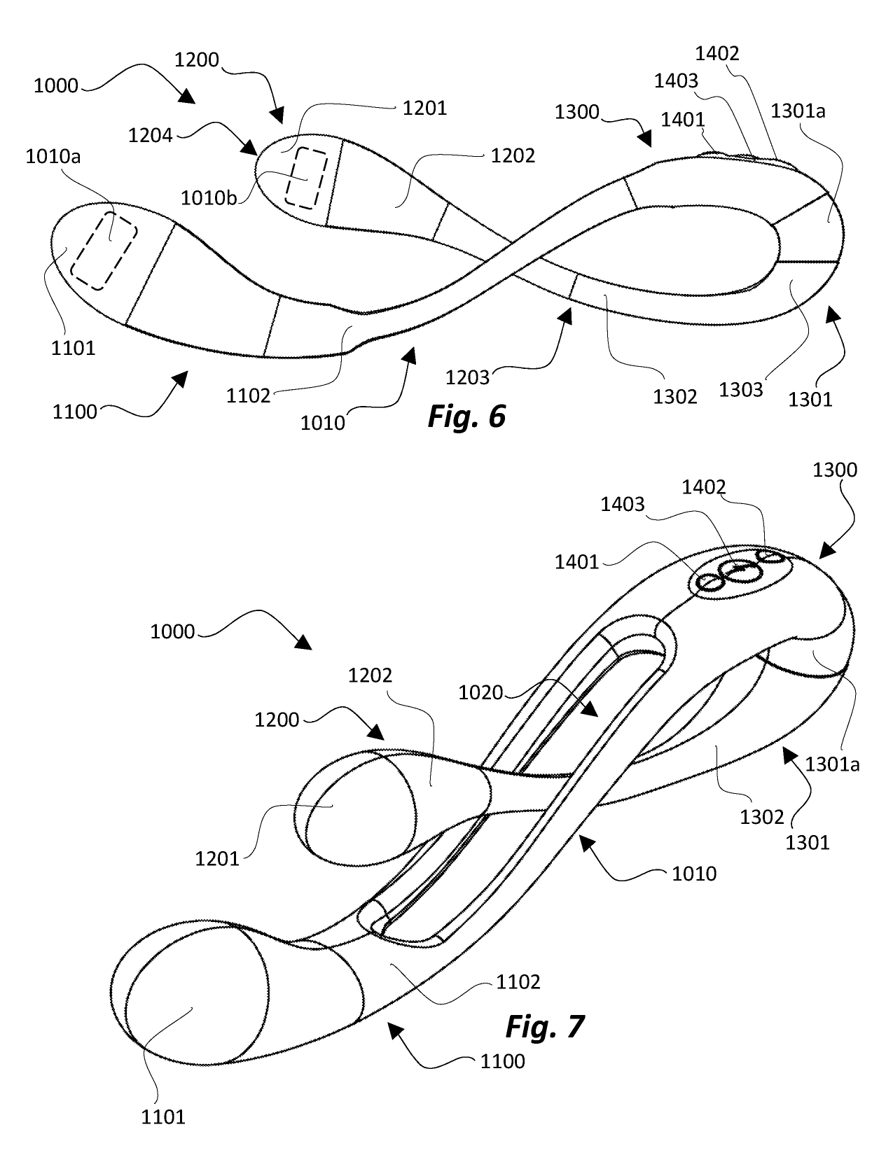

FIGS. 6 through 16 illustrate various exemplary embodiments of the exemplary disclosed sexual stimulation device. The exemplary disclosed sexual stimulation device may include components generally similar to female accessory 315 (e.g., and/or male accessory 308). The exemplary disclosed interactive sexual device may be used in system 300 described above, for example similarly to (e.g., used as or in place of) female accessory 315 (e.g., and/or male accessory 308). The exemplary disclosed sexual stimulation device may include a first stimulating member that may be configured to be inserted into a body orifice (e.g., a vaginal opening or an anal opening) and to enter a cavity such as a vagina or a rectum. The exemplary disclosed sexual stimulation device may also include a second stimulating member that may include a second stimulating end that may be configured to contact an outer surface of the human body such as, for example, a sensitive and/or erogenous region or zone (e.g., a clitoris, vulva, perineum, or other erogenous area).

FIGS. 6 through 11 illustrate a first exemplary embodiment of the exemplary disclosed sexual stimulation device (e.g., a sexual stimulation device 1000). As illustrated in FIGS. 6, 8, and 10, sexual stimulation device 1000 may include a main body 1010. Main body 1010 may be formed by an elongated member such as an elongated rod that may be bent at least once (e.g., bent two, three, or more times). Main body 1010 may be formed from any suitable structural material such as, for example, structural plastic and/or metal material. In at least some exemplary embodiments, main body 1010 may be formed from plastic material such as High-Density Polyethylene (HDPE), Polypropylene (PP), Polyvinyl Chloride (PVC), Acrylonitrile-Butadiene-Styrene (ABS), Polycarbonate (PC), Polymethyl Methacrylate (PMMA), and/or any other suitable structural material. In at least some exemplary embodiments, exterior surfaces of main body 1010 may be coated and/or covered with grippable material such as, for example, rubber or elastomeric material, plastic, polyurethane, plastisol, and/or any other suitable material to facilitate grasping of sexual stimulation device 1000.

Main body 1010 (e.g., an elongated member such as an elongated rod) may include a first stimulating member 1100 having a first stimulating end (e.g., first stimulating end portion 1101) and a second stimulating member 1200 having a second stimulating end (e.g., second stimulating end portion 1201). A hand-held portion 1300 may be disposed between first stimulating member 1100 and second stimulating member 1200. First stimulating member 1100 having first stimulating end portion 1101, second stimulating member 1200 having second stimulating end portion 1201, and hand-held portion 1300 may be integral portions of sexual stimulation device 1000. Alternatively for example, first stimulating member 1100 and second stimulating member 1200 may be attached to sides of hand-held portion 1300 via any suitable attachment technique such as, for example, mechanical connectors (e.g., fasteners such as screws or bolts), adhesive, snap-fit or press-fit connection, and/or any other suitable connection technique. First stimulating end portion 1101 may be disposed at a first distal end of main body 1010 that may be at an opposite end of main body 1010 from second stimulating end portion 1201 (e.g., that may be disposed at a second distal end of main body 1010). Based on main body 1010 being bent (e.g., curved), first stimulating end portion 1101 and second stimulating end portion 1201 may be disposed at different positions such as at different sides and/or elevation (e.g., different heights) relative to a user holding main body 1010. In at least some exemplary embodiments, first stimulating end portion 1101 may be positioned below second stimulating end portion 1201 (e.g., when sexual stimulation device 1000 is positioned as illustrated in FIGS. 6, 7, 10, and 11).

In at least some exemplary embodiments, main body 1010 may be bent a plurality of times (e.g., to form a plurality of bent portions). For example, main body 1010 may be bent to form a first bent portion 1102, a second bent portion 1202, and a third bent portion 1301. First bent portion 1102, second bent portion 1202, and third bent portion 1301 may be integral portions of sexual stimulation device 1000 (e.g., including main body 1010). First bent portion 1102 may be part of (e.g., may constitute at least a part of) first stimulating member 1100, second bent portion 1202 may be part of (e.g., may constitute at least a part of) second stimulating member 1200, and third bent portion 1301 may be a part of (e.g., may constitute at least a part of) hand-held portion 1300 of sexual stimulation device 1000.

As a first exemplary feature of the exemplary disclosed sexual stimulation device and for example as illustrated in FIGS. 6 through 11, the exemplary disclosed (e.g., illustrated) relative positions may intersect (e.g., provide for a crossing arrangement) of the exemplary disclosed bent portions of the exemplary disclosed main body (e.g., main body 1010). The crossing arrangement may allow for relative rotation between the exemplary disclosed first and second stimulating members based on the exemplary disclosed configurations or states described below. Third bent portion 1301 may include a first position portion 1301a and a second position portion 1302. First position portion 1301a may be disposed at a different elevation or height from second position portion 1302 based on the exemplary disclosed curves (e.g., and orientation) of main body 1010. For example, first position portion 1301a may be disposed above second position portion 1302. For example, first position portion 1301a may be disposed at a first side (e.g., an upper side) of hand-held portion 1300, and second position portion 1302 may be disposed at a second side (e.g., a lower side) of hand-held portion 1300. First stimulating member 1100 may extend from first position portion 1301a to first stimulating end portion 1101, and second stimulating member 1200 may extend from second position portion 1302 to second stimulating end portion 1201, so that first and second stimulating members 1100 and 1200 are configured (e.g., arranged) to cross each other as illustrated in FIGS. 6 through 11.

As a second exemplary feature of the exemplary disclosed sexual stimulation device and for example as illustrated in FIGS. 6-11, a built-in actuator and/or control module may be provided. First stimulating end portion 1101 and/or second stimulating end portion 1201 of main body 1010 may include (e.g., internally include) one or more actuators 1010a and/or actuators 1010b (e.g., as illustrated in FIG. 6). Actuator 1010a may be generally similar to the exemplary disclosed actuator mechanism of system 300 described above (e.g., including motor 316). Actuator 1010a and/or actuator 1010b may provide at least one type of stimulation including for example patting, pressing, vibrating, oscillating, rotating, reciprocating, swinging, waving, heating, cooling, and/or micro-current stimulation.

The exemplary disclosed sexual stimulation device may also include a control module that may include components similar to as described above regarding controller 319. Sexual stimulation device 1000 may include a control module having at least one interface component such as a button, dial, touchscreen, and/or any other suitable interface components. For example, sexual stimulation device 1000 may include a control module having three buttons including a first button 1401, a second button 1402, and a third button 1403. First button 1401 and second button 1402 may control respective exemplary disclosed actuators. For example, first button 1401 may control (e.g., control an actuation of) actuator 1010a disposed in or at first stimulating end portion 1101, and second button 1402 may control (e.g., control an actuation of) actuator 1010b disposed in or at second stimulating end portion 1201. Third button 1403 may control a power level function of actuators 1010a and/or 1010b. For example, third button 1403 may control (e.g., control an actuation of) actuators 1010a and/or 1010b to operate at a desired power level such as a maximum output power. A user of sexual stimulation device 1000 may thereby use the exemplary disclosed control module (e.g., first button 1401, second button 1402, and/or third button 1403) to operate as desired.

As a third exemplary feature of the exemplary disclosed sexual stimulation device and for example as illustrated in FIGS. 6-11, a through-hole configuration may be provided. Main body 1010 of sexual stimulation device 1000 may be a substantially solid body (e.g., entity) defined by an entire exterior wall or layer (e.g., outer contour) of sexual stimulation device 1000. In at least some exemplary embodiments, a through-hole (e.g., a through-hole 1020 such as a single through-hole) may be formed in main body 1010. For example, through-hole 1020 may be defined topologically as an aperture extending through (e.g., a unique hole penetrating through) sexual stimulation device 1000. Second stimulating end portion 1201 may pass from a first side (e.g., a lower side) of main body 1010, extend through through-hole 1020, and extend through (e.g., and out of) a second side (e.g., an upper side) of main body 1010. For example, after extending through through-hole 1020, second stimulation portion 1201 may extend past the second side (e.g., upper side) and remain at the second side (e.g., upper side) for example as illustrated in FIGS. 7, 9, and 11.

FIG. 13 illustrates another exemplary embodiment of the exemplary disclosed sexual stimulation device (e.g., sexual stimulation device 3000). Sexual stimulation device 3000 may include a main body 3010 that may be generally similar to main body 1010. Main body 3010 may include a first stimulating member 3100 having a first stimulating end (e.g., first stimulating end portion 3101), which may be generally similar to first stimulating member 1100 having first stimulating end portion 1101. Main body 3010 may also include a second stimulating member 3200 having a second stimulating end (e.g., second stimulating end portion 3201), which may be generally similar to second stimulating member 1200 having second stimulating end portion 1201. Main body 3010 may also include a hand-held portion 3300 that may be generally similar to hand-held portion 1300. Sexual stimulation device 3000 may also have a control module similar to as described above regarding sexual stimulation device 1000. Similar to through-hole 1020 formed in main body 1010, a through-hole 3020 may be formed in main body 3010. Second stimulating end portion 3201 may pass from a second side (e.g., upper side) of main body 3010, extend through through-hole 3020, and extend to a first side (e.g., lower side) of main body 3010, and remain at (e.g., on) the first side (e.g., lower side).

The exemplary disclosed sexual stimulation device may have any number of through-holes (e.g., through-holes 1020 and/or 3020) formed in the exemplary disclosed main body. For example, additional apertures similar to the exemplary disclosed through-holes may be formed in (e.g., extend through) the exemplary disclosed main body for functional and/or decorative purposes. In at least some exemplary embodiments, a plurality of through-holes may be provided so that after the exemplary disclosed second stimulating end portion (e.g., second stimulating end portion 1201 or second stimulating end portion 3201) passes from the lower side of the exemplary disclosed main body and through a first through-hole 1020 and extends to the upper side of the main body, the second stimulating end portion may then pass through another through-hole (e.g., through-hole 3020) also formed in the main body from the upper side and back to the lower side (e.g., and this may be repeated alternately through additional through-holes disposed in the main body). For example, one or more through-holes 1020 illustrated in FIGS. 7, 9, and 11 and one or more through-holes 3020 illustrated in FIG. 13 may be provided in a given main body (e.g., with a single stimulating end portion or multiple stimulating end portions passing through the through-holes).

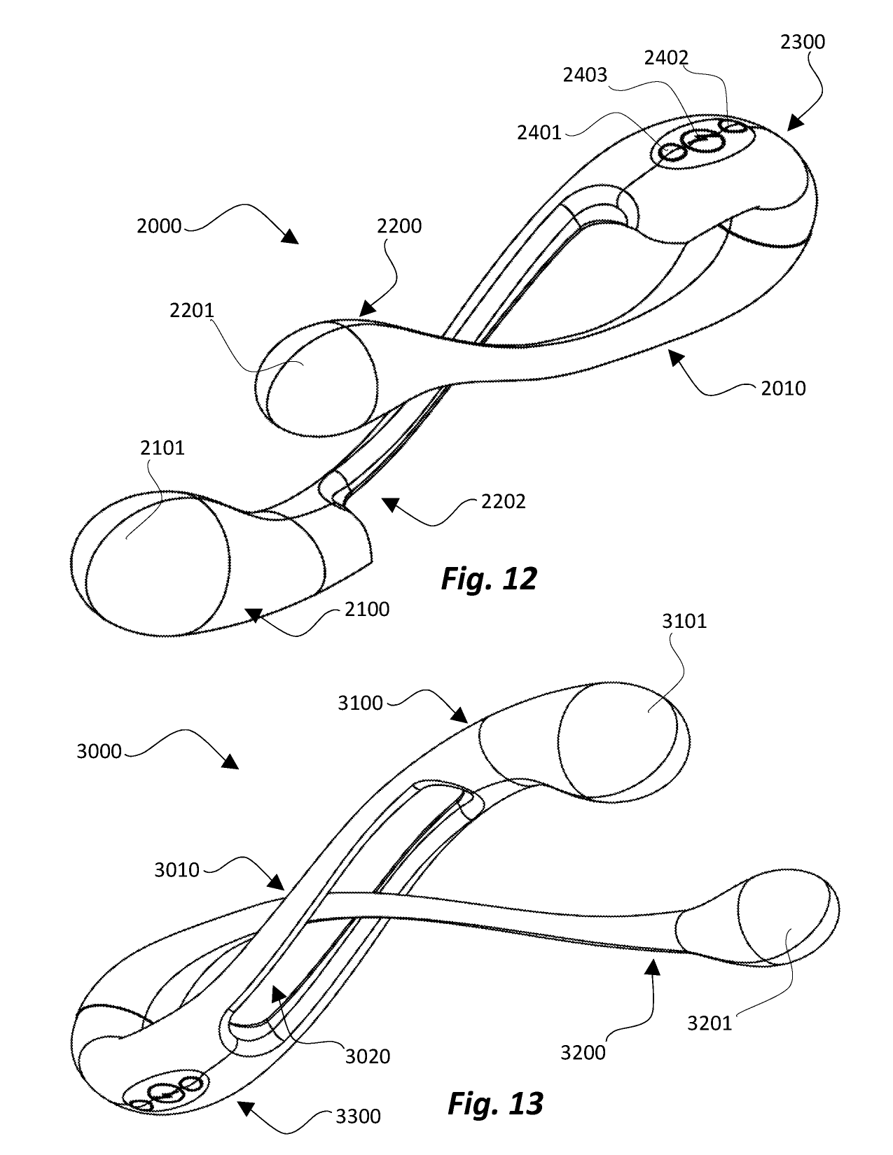

As a fourth exemplary feature of the exemplary disclosed sexual stimulation device and for example as illustrated in FIG. 12, a configuration including a crossing of stimulation members without a through-hole may be provided. A sexual stimulation device 2000 may include a main body 2010 that may be generally similar to main body 1010. Main body 2010 may include a first stimulating member 2100 having a first stimulating end (e.g., first stimulating end portion 2101), which may be generally similar to first stimulating member 1100 having first stimulating end portion 1101. Main body 2010 may also include a second stimulating member 2200 having a second stimulating end (e.g., second stimulating end portion 2201), which may be generally similar to second stimulating member 1200 having second stimulating end portion 1201. Main body 2010 may also include a hand-held portion 2300 that may be generally similar to hand-held portion 1300. Main body 2010 may also include a control module having first button 2401, second button 2402, and third button 2403, which may be similar to the control module of sexual stimulation device 1000 including first button 1401, second button 1402, and third button 1403. Second stimulating end portion 2201 of main body 2010 may extend from a first side (e.g., lower side) of main body 2010, by a side of first stimulating member 2100 (e.g., at or near a second bent portion 2202 that may be similar to second bent portion 1202), and then to a second side (e.g., upper side) of main body 2010, where second stimulating end portion 2201 may remain disposed. The exemplary disclosed configuration of at least some exemplary embodiments may thereby not involve a through-hole.

As a fifth exemplary feature of the exemplary disclosed sexual stimulation device and for example as illustrated in FIGS. 6, 8, and 10, a flexible connection may be provided. Second stimulating member 1200 may include (e.g., define) a free end 1204 (e.g., at second stimulating end portion 1201) and a fixed end 1203. For example, second stimulating end portion 1201 may be located at free end 1204. Fixed end 1203 may be connected to second position portion 1302 of hand-held portion 1300 via a bendable connector 1303. Bendable connector 1303 may be formed from any suitable flexible or elastic material such as elastomeric material, natural or synthetic rubber material, and/or any other suitable material that may be flexible (e.g., and/or that may store and release potential energy when moved or deformed). For example, bendable connector 1303 may be deformed when a user applies a force to main body 1010 to move first stimulating member 1100 and second stimulating member 1200 relative to each other for example as illustrated in FIGS. 6 through 11. Bendable connector 1303 may be formed from any suitable material and/or have any suitable configuration for providing the exemplary disclosed movements (e.g., flexible configurations) described herein.

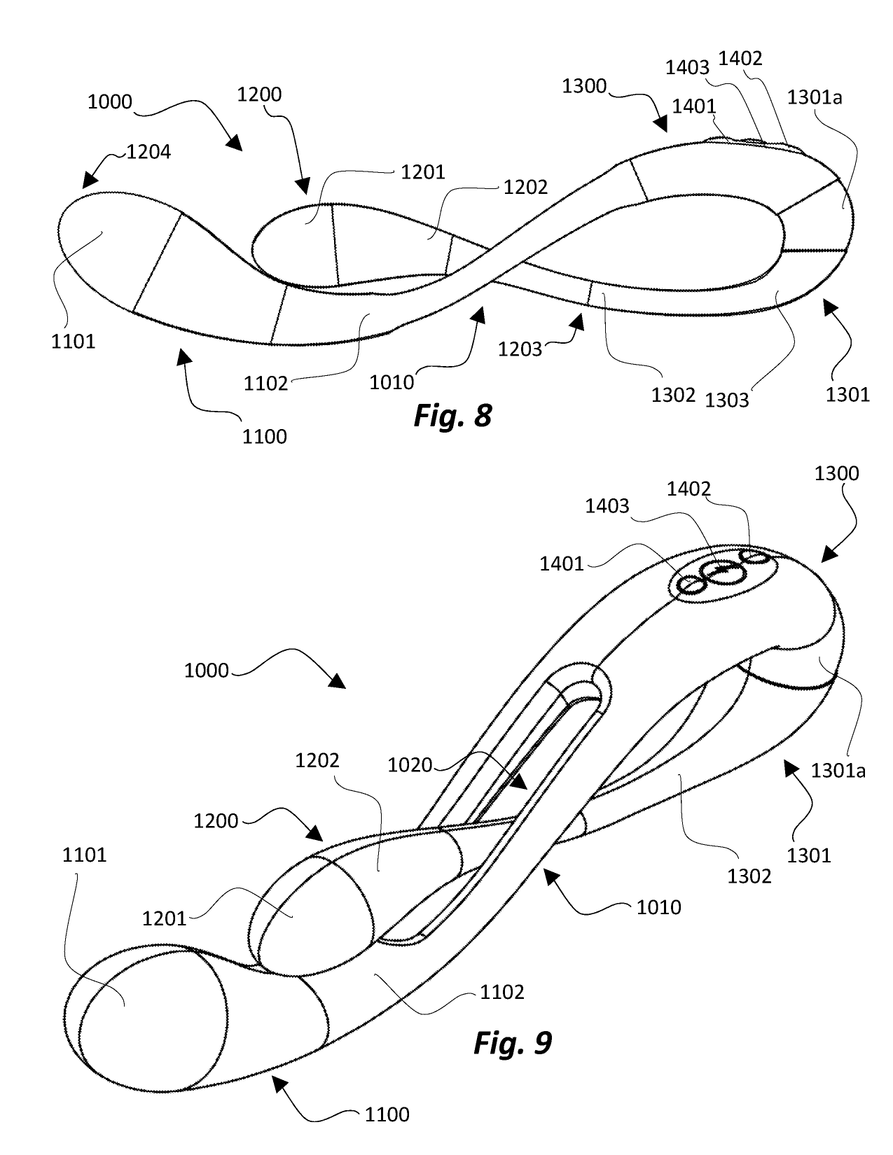

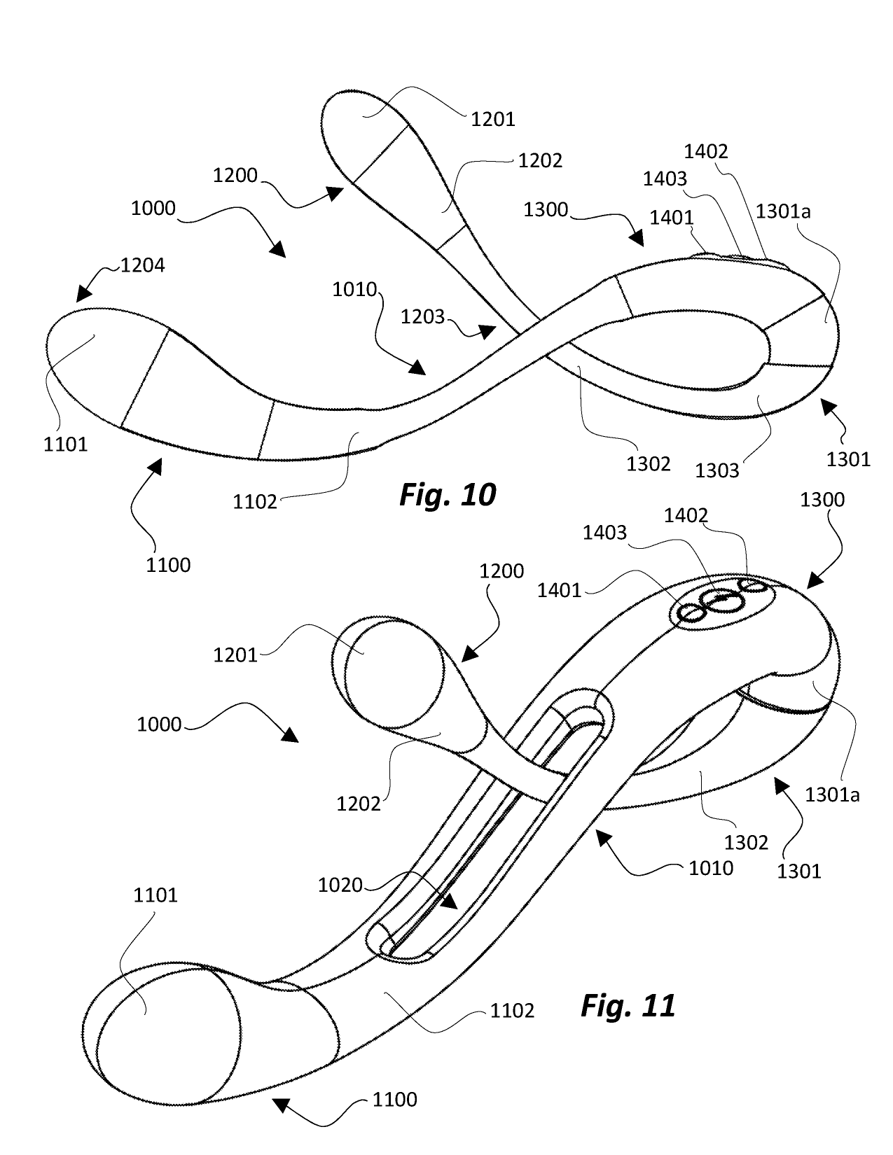

As a sixth exemplary feature of the exemplary disclosed sexual stimulation device and for example as illustrated in FIGS. 6 through 11, a plastic bendable connector may be provided. In at least some exemplary embodiments, bendable connector 1303 may be plastic (e.g., bendable or flexible plastic). Sexual stimulation device 1000 may respond to a user’s manipulation (e.g., operation) of hand-held portion 1300 to change a configuration of sexual stimulation device 1000 (e.g., switch a structural configuration of sexual stimulation device 1000) between an initial state for example as illustrated in FIGS. 6 and 7, a compressed state for example as illustrated in FIGS. 8 and 9, and an expanded state for example as illustrated in FIGS. 10 and 11.

A user may bend the exemplary disclosed main body (e.g., main body 1010 including bendable connector 1303) of the exemplary disclosed sexual stimulation device (e.g., sexual stimulation device 1000) to be in the initial state for example as illustrated in FIGS. 6 and 7. When sexual stimulation device 1000 is utilized by a user in the initial state, as first stimulating member 1100 moves into and/or out of a body orifice (e.g., a vaginal opening), second stimulating end portion 1201 of second stimulating member 1200 may contact (e.g., intermittently strike) a sensitive region of the user (e.g., a sensitive region of the user on the outer surface such as, for example, the clitoris or other erogenous zone).

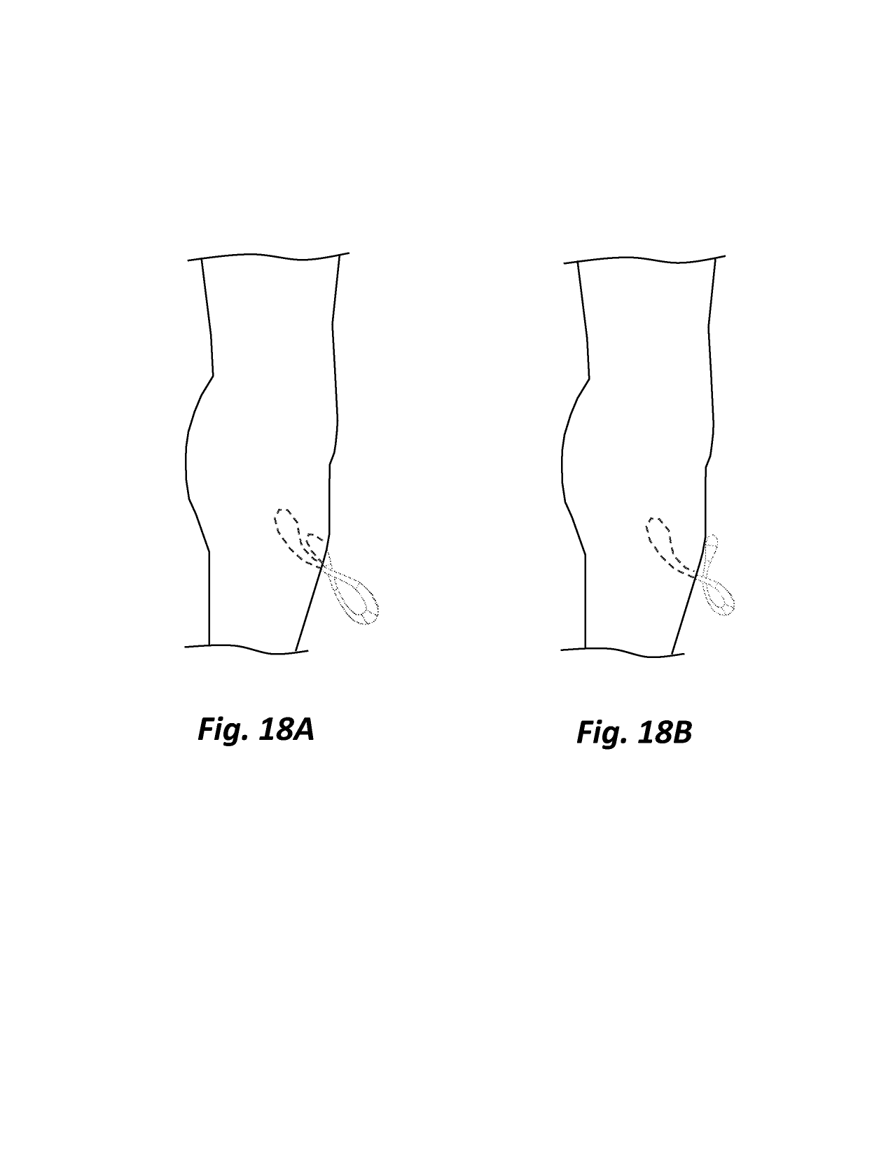

A user may bend the exemplary disclosed main body (e.g., main body 1010 including bendable connector 1303) of the exemplary disclosed sexual stimulation device (e.g., sexual stimulation device 1000) to be in the compressed state for example as illustrated in FIGS. 8 and 9. When sexual stimulation device 1000 is utilized by a user in the compressed state, a distance (e.g., spacing) between first stimulating end portion 1101 and second stimulating end portion 1201 may decrease (e.g., may decrease in response to the user’s operation and remain decreased or reduced for any time period desired by the user). In the compressed state that may be a first configuration, the two stimulating ends may be relatively close to each other (e.g., first stimulating end portion 1101 and second stimulating end portion 1201 may be closely fitted), allowing for both first stimulating end portion 1101 and second stimulating end portion 1201 to be simultaneously inserted into a body orifice (e.g., vagina or anus) for example as illustrated in FIG. 18A.

A user may bend the exemplary disclosed main body (e.g., main body 1010 including bendable connector 1303) of the exemplary disclosed sexual stimulation device (e.g., sexual stimulation device 1000) to be in the expanded state (e.g., which may be a second configuration) for example as illustrated in FIGS. 10 and 11. When sexual stimulation device 1000 is utilized by a user in the expanded state, the distance (e.g., spacing) between first stimulating end portion 1101 and second stimulating end portion 1201 may be increased and may remain increased (e.g., enlarged) in response to the user’s operation of sexual stimulation device 1000. For example, the increased distance or spacing may allow for first stimulating member 1100, when inserted into an orifice (e.g., vagina or anus), to move freely (e.g., be moved freely by the user) while the second stimulating end portion 1201 remains in contact with a sensitive region such as the clitoris or other erogenous zone (e.g., according to the user’s anatomy) for example as illustrated in FIG. 18B.

In at least some exemplary embodiments, the initial state illustrated in FIGS. 6 and 7 may be an at rest or default state of the exemplary disclosed sexual stimulation device. For example when the user is not applying force (e.g., not contacting and/or deforming or bending the exemplary disclosed main body such as main body 1010 including bendable connector 1303), the exemplary disclosed sexual stimulation device may be in the initial state illustrated in FIGS. 6 and 7. By applying force to (e.g., deforming or bending) main body 1010 including bendable connector 1303, the user may move main body 1010 from the initial state illustrated in FIGS. 6 and 7 toward or to either the compressed state illustrated in FIGS. 8 and 9 or the expanded state illustrated in FIGS. 10 and 11. When the user is finished utilizing the exemplary disclosed sexual stimulation device (e.g., and external forces are no longer substantially applied to main body 1010 by the user), main body 1010 may return to the initial state illustrated in FIGS. 6 and 7. Alternatively for example, the compressed state illustrated in FIGS. 8 and 9 or the expanded state illustrated in FIGS. 10 and 11 may be the exemplary disclosed at rest or default state.

As a seventh exemplary feature of the exemplary disclosed sexual stimulation device and for example as illustrated in FIGS. 6 through 11, an elastic bendable connector may be provided. For example, bendable elastic connector 1303 may be formed from any suitable elastic material that allows for relatively significant flexibility of main body 1010 (e.g., relatively large movement or deformation of second stimulating member 1200 relative to first stimulating member 1100). In at least some exemplary embodiments, when bendable connector 1303 is elastic, the exemplary disclosed sexual stimulation device (e.g., sexual stimulation device 1000) may respond elastically to a user’s manipulation (e.g., continuous operation) of hand-held portion 1300. The user may manually drive the exemplary disclosed sexual stimulation device. For example, the user may make a gesture operation such as gripping and/or expanding hand-held portion 1300 (e.g., a ring-shaped body or space of hand-held portion 1300), which may change (e.g., switch) the configuration of hand-held portion 1300 (e.g., and main body 1010) between the initial state illustrated in FIGS. 6 and 7, the compressed state illustrated in FIGS. 8 and 9, and the expanded state illustrated in FIGS. 10 and 11. The gesture operation may be a one-handed gesture operation. For example, the exemplary disclosed intersecting of the stimulating members (e.g., exemplary disclosed crossing arrangement) may allow for relative rotation between the first and second stimulating members when moving between the exemplary disclosed configurations (e.g., initial state, compressed state, and expanded state) based on hand-held portion 1300 being gripped and/or expanded by a gesture operation of a user’s hand (e.g., one of the user’s hands).

A user may manipulate (e.g., grip and/or expand) bendable connector 1303 of the exemplary disclosed sexual stimulation device (e.g., sexual stimulation device 1000) so that main body 1010 is in the compressed state for example as illustrated in FIGS. 8 and 9. When sexual stimulation device 1000 is utilized by a user in the compressed state, a distance (e.g., spacing) between first stimulating end portion 1101 and second stimulating end portion 1201 may decrease (e.g., may decrease in response to the user’s operation and remain decreased or reduced for any time period desired by the user). In the compressed state, the two stimulating ends (e.g., first stimulating end portion 1101 and second stimulating end portion 1201) may be disposed relatively close to each other and/or tightly contact each other, allowing simultaneous insertion of first stimulating end portion 1101 and second stimulating end portion 1201 into the orifice (e.g., vagina or anus of the user). When bendable connector 1303 is elastic, second stimulating end portion 1201 of second stimulating member 1200 may tend to rebound away (e.g., may be urged) from first stimulating member 1100 (e.g., rebound, for example rebound upward), which may generate a compressive stress against an inner sensitive region (e.g., the G-spot or prostate) contacted by second stimulating end portion 1201, which may enhance stimulation of the inner sensitive region.

A user may manipulate (e.g., grip and/or expand) bendable connector 1303 of the exemplary disclosed sexual stimulation device (e.g., sexual stimulation device 1000) so that main body 1010 is in the expanded state for example as illustrated in FIGS. 10 and 11. When sexual stimulation device 1000 is utilized by a user in the expanded state, a distance (e.g., spacing) between first stimulating end portion 1101 and second stimulating end portion 1201 may increase, and elastic connector 1303 (e.g., based on its elastic properties) may cause second stimulating end portion 1201 of second stimulating member 1200 to rebound toward first stimulating member 1100 (e.g., rebound downward), thereby generating compressive stress that may provide stimulation (e.g., follow-up stimulation) on the outer sensitive region (e.g., the clitoris of the user). For example, as first stimulating member 1100 moves into or out of the body orifice (e.g., vagina of the user), second stimulating end portion 1201 may remain in continuous contact with the outer sensitive region (e.g., the clitoris).

In at least some exemplary embodiments in which the main body includes an elastic connector, the structural deformation tendency of the main body may be defined at least in part by an elastic restoring force of the elastic connector. Accordingly, when the user performs a gesture operation on the hand-held portion in a direction aligned with such elastic restoring force, the main body may deform along the continuous deformation path in a manner that is facilitated by the inherent elastic bias of the structure. In this sense, the gesture operation may be performed “along” or “with” the natural deformation tendency of the main body rather than against it.

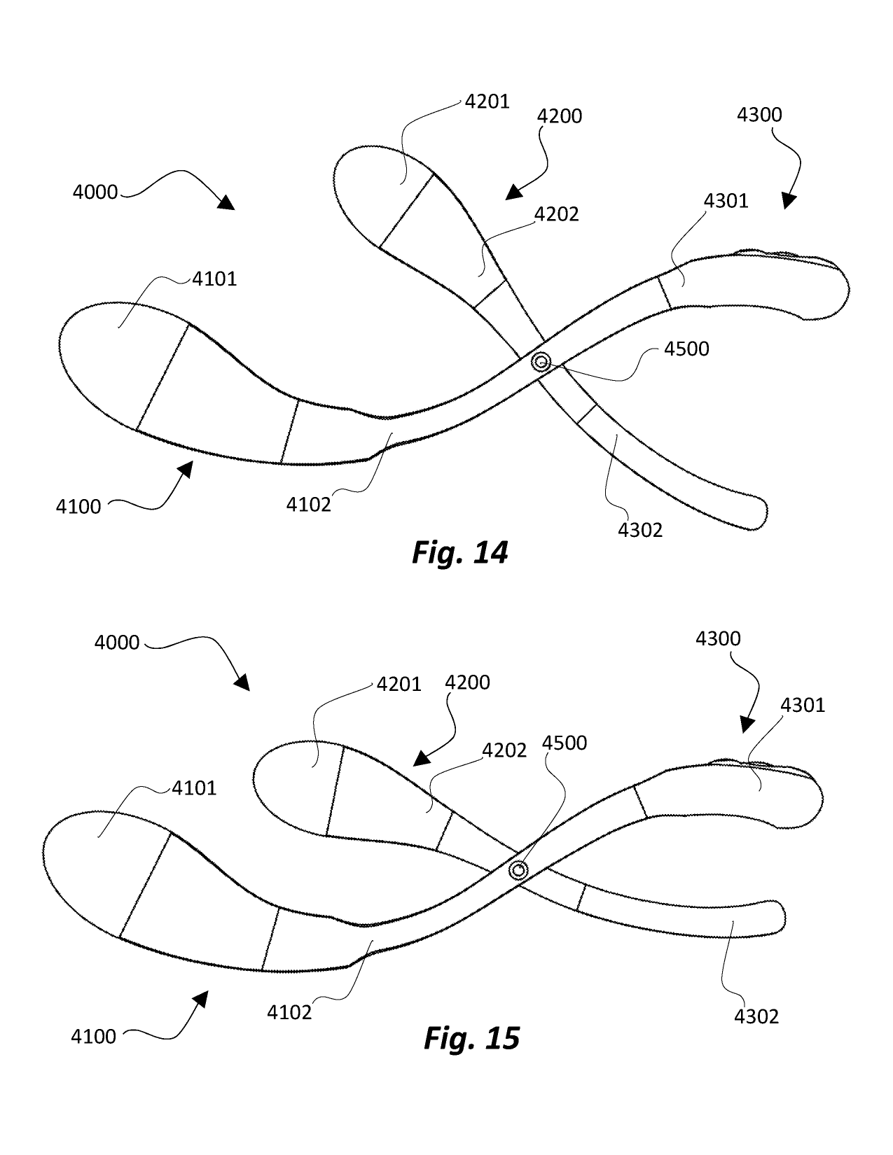

As an eighth exemplary feature of the exemplary disclosed sexual stimulation device and for example as illustrated in FIGS. 14 through 16, a configuration including an elastic pivot joint and pressing sections may be provided. A sexual stimulation device 4000 may include a first stimulating member 4100 having a first stimulating end (e.g., first stimulating end portion 4101), which may be generally similar to first stimulating member 1100 having first stimulating end portion 1101. Sexual stimulation device 4000 may also include a second stimulating member 4200 having a second stimulating end (e.g., second stimulating end portion 4201), which may be generally similar to second stimulating member 1200 having second stimulating end portion 1201. Sexual stimulation device 4000 may also include a control module, which may be similar to the control module of sexual stimulation device 1000 including first button 1401, second button 1402, and third button 1403. A main body of sexual stimulation device 4000 may comprise first stimulating member 4100 and second stimulating member 4200, which may be movably connected via a fastener 4500 that may be an elastic pivot joint or any other suitable connector (e.g., rotatable connector such as a pin). For example, fastener 4500 may be a pivot joint (e.g., elastic pivot joint) that rotatably fastens first stimulating member 4100 and second stimulating member 4200.

Sexual stimulation device 4000 may further include a first bent portion 4102 of first stimulating member 4100 that may be generally similar to first bent portion 1102, and a second bent portion 4202 of second stimulating member 4200 that may be generally similar to second bent portion 1202. Sexual stimulation device 4000 may also include a hand-held portion 4300 that may include a first pressing section 4301 and a second pressing section 4302. First pressing section 4301 may be an integral portion of (e.g., or attached to) first stimulating portion 4100, and second pressing section 4302 may be an integral portion of (e.g., or attached to) second stimulating portion 4200. First pressing section 4301 and second pressing section 4302 may be configured to cause at least one state or configuration change (e.g., a plurality of configuration changes) of sexual stimulation device 4000 in response to a user gripping first pressing section 4301 and second pressing section 4302 (e.g., a gripping operation by a user’s hand of first pressing section 4301 and second pressing section 4302). First stimulating member 4100, second stimulating member 4200, and hand-held portion 4300 may thereby be moved by a user between different states (e.g., configurations) for example as described below.

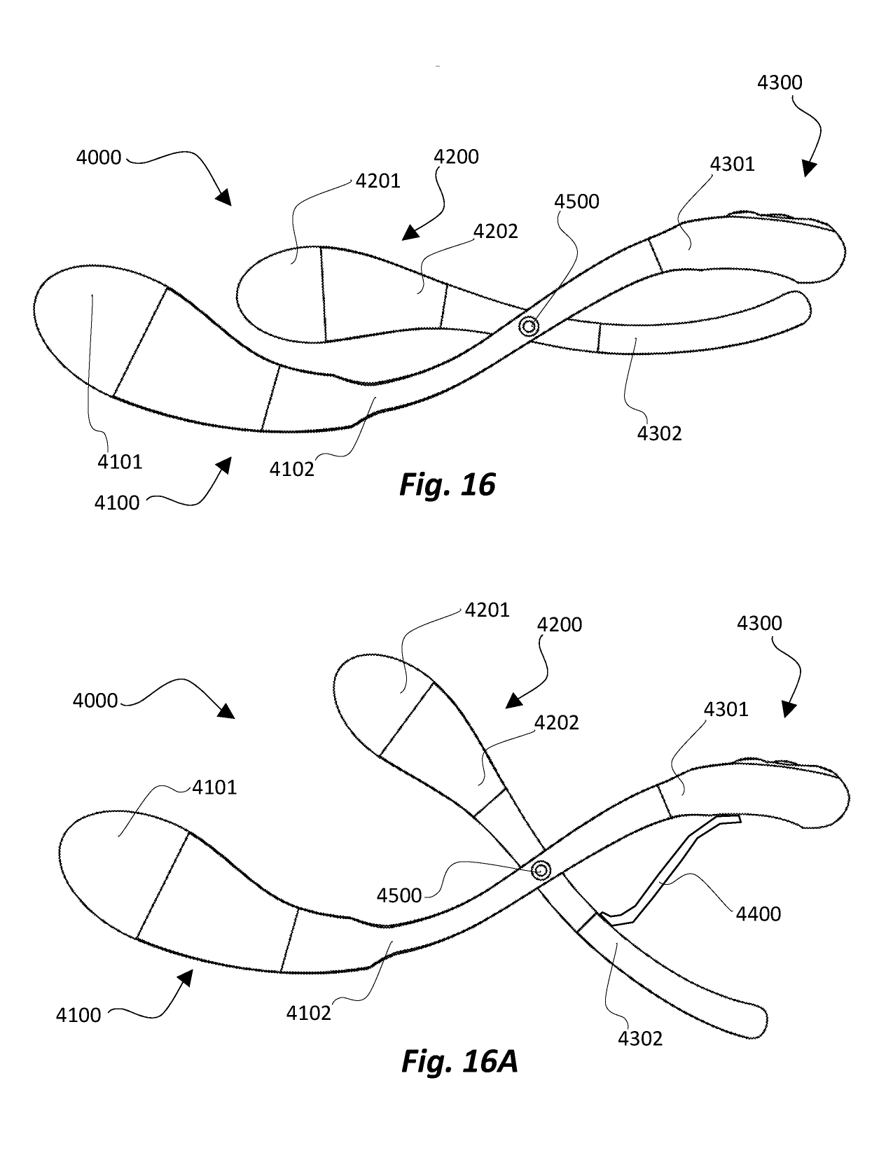

Fastener 4500 may be an elastic pivot joint or any other suitable connector (e.g., rotatable connector such as a pin) that may cause sexual stimulation device 4000 to be in an initial state (e.g., initial configuration) for example as illustrated in FIG. 15. The initial state of sexual stimulation device 4000 may be a default or at rest state when substantially no external forces are applied to sexual stimulation device 4000 by a user (e.g., when a user is not gripping first pressing section 4301 and second pressing section 4302) similar to the at rest or default state described above regarding sexual stimulation device 1000. For example, fastener 4500 may be an elastic fastener that returns sexual stimulation device 4000 to the initial state illustrated in FIG. 15 when substantially no external force is applied to sexual stimulation device 4000 (e.g., by a user). Alternatively for example, the states illustrated in FIGS. 14 or 16 may be the at rest or default state of sexual stimulation device 4000.

When the user makes a gesture operation such as gripping hand-held portion 4300 to bring first pressing section 4301 and second pressing section 4302 closer together, sexual stimulation device 4000 may move (e.g., change) to the compressed state or configuration for example as illustrated in FIG. 16. The gesture operation may be a one-handed gesture operation. Also for example, when the fingers of the user are spread apart while holding hand-held portion 4300 to move first pressing section 4301 and second pressing section 4302 away from each other, sexual stimulation device 4000 may move (e.g., change) to the expanded state or configuration for example as illustrated in FIG. 14.

In at least some exemplary embodiments, the expanded state or configuration of FIG. 14 may be an at rest or default (e.g., initial) state or configuration of sexual stimulation device 4000. When the user grips hand-held portion 4300 to bring first pressing section 4301 and second pressing section 4302 closer together, sexual stimulation device 4000 may first move (e.g., change) to the state or configuration of FIG. 15. When the user continues to grip hand-held portion 4300 to bring first pressing section 4301 and second pressing section 4302 increasingly close together, sexual stimulation device 4000 may then move (e.g., change) to the compressed state or configuration for example as illustrated in FIG. 16.

In at least some exemplary embodiments, the exemplary disclosed elastic connector (e.g., elastic pivot joint) may be implemented by a resilient member 4400 such as a spring plate, a spring leaf, a torsion spring, a compression spring, and/or any other suitable resilient member. For example, as illustrated in FIG. 16A, a resilient member 4400 (e.g., a spring plate or a spring leaf) may have a first end coupled to first pressing section 4301 and a second end coupled to second pressing section 4302. Resilient member 4400 may be configured to elastically deform when first pressing section 4301 and second pressing section 4302 are moved toward or away from each other by a user, thereby storing elastic potential energy and providing a restoring force that may urge the exemplary disclosed sexual stimulation device toward an initial configuration.

In such exemplary embodiments, resilient member 4400 may constitute at least a portion of an elastic pivot joint that rotatably and elastically couples first stimulating member 4100 and second stimulating member 4200. In at least some exemplary embodiments, a separate fastener such as fastener 4500 may be omitted, and resilient member 4400 alone may provide both elastic biasing and relative rotational movement between the first stimulating member and the second stimulating member. In at least some exemplary embodiments, second stimulating member 4200 may extend through a through-hole (e.g., similar to through-hole 1020) formed in first stimulating member 4100, such that second stimulating member 4200 passes through first stimulating member 4100 while remaining elastically and rotatably coupled thereto by resilient member 4400.

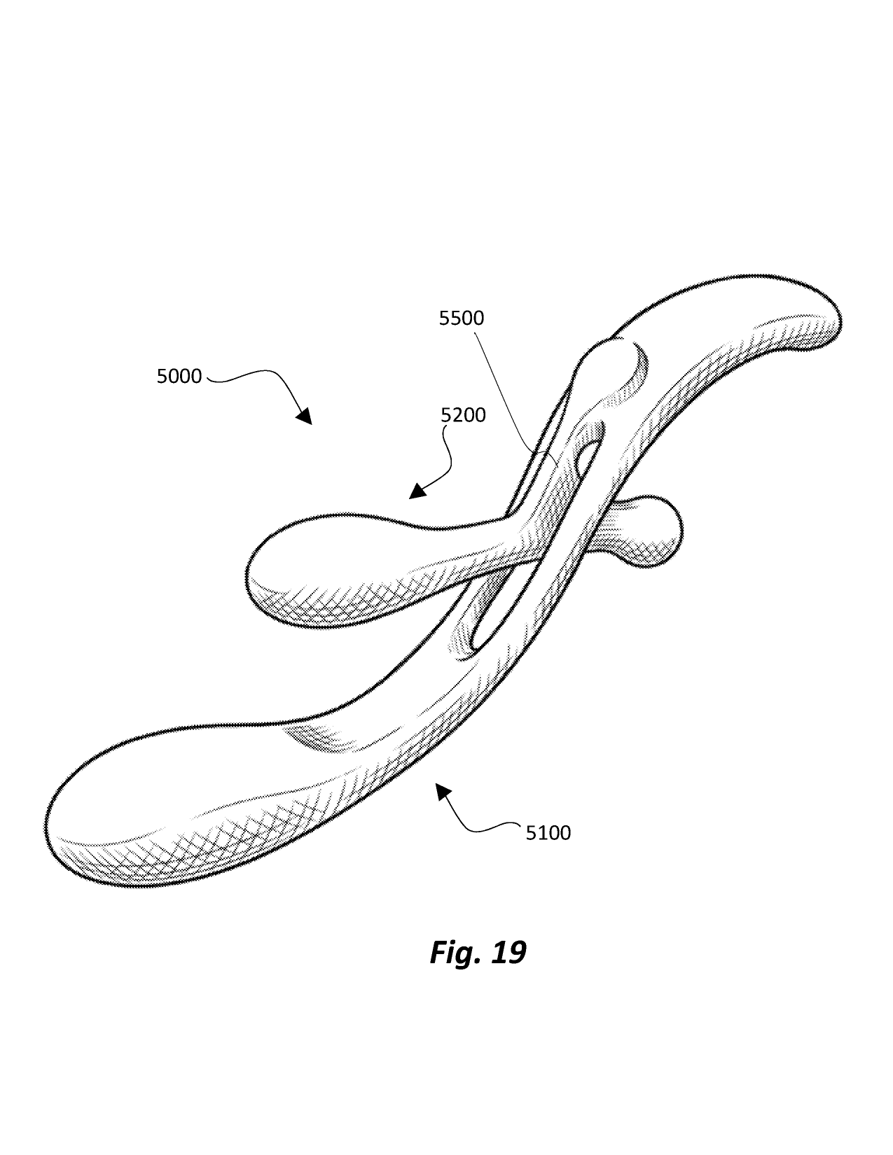

FIG. 19 illustrates another exemplary embodiment of the exemplary disclosed sexual stimulation device. A sexual stimulation device 5000 may include a first stimulating member 5100, which may be generally similar to first stimulating member 1100, and a second stimulating member 5200, which may be generally similar to second stimulating member 1200. First stimulating member 5100 and second stimulating member 5200 may be elastically coupled to each other by an elastic connector 5500 that may allow relative rotational movement between first stimulating member 5100 and second stimulating member 5200 while maintaining an intersecting relationship between first stimulating member 5100 and second stimulating member 5200 similar for example to described above regarding sexual stimulation device 1000. Elastic connector 5500 may provide a similar operation as described above regarding bendable elastic connector 1303. For example, elastic connector 5500 may be formed from any suitable elastic material that allows for relatively significant flexibility (e.g., relatively large movement or deformation) of second stimulating member 5200 relative to first stimulating member 5100. In at least some exemplary embodiments, when elastic connector 5500 is elastic, the exemplary disclosed sexual stimulation device (e.g., sexual stimulation device 5000) may respond elastically to a user’s manipulation (e.g., continuous operation). Elastic connector 5500 may be integrally formed with and/or attached between first stimulating member 5100 and second stimulating member 5200 for example as illustrated in FIG. 19.

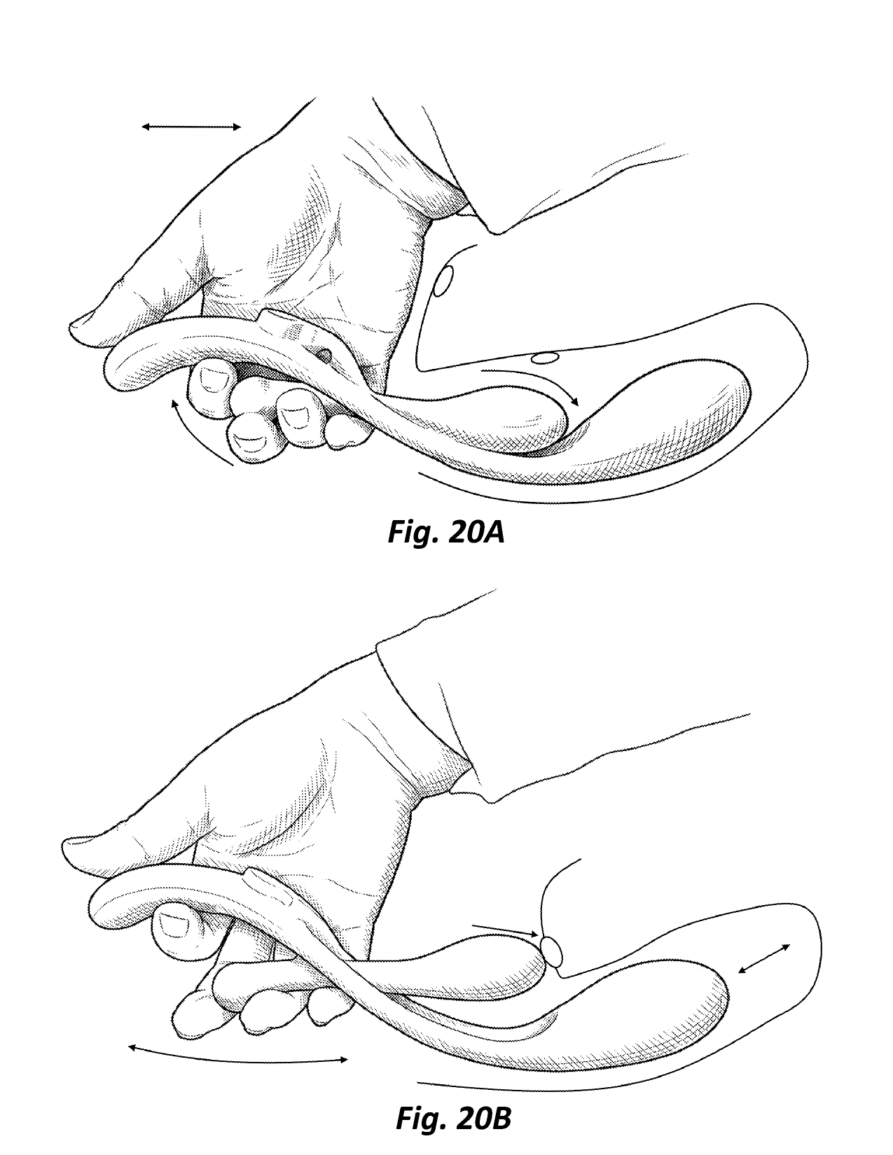

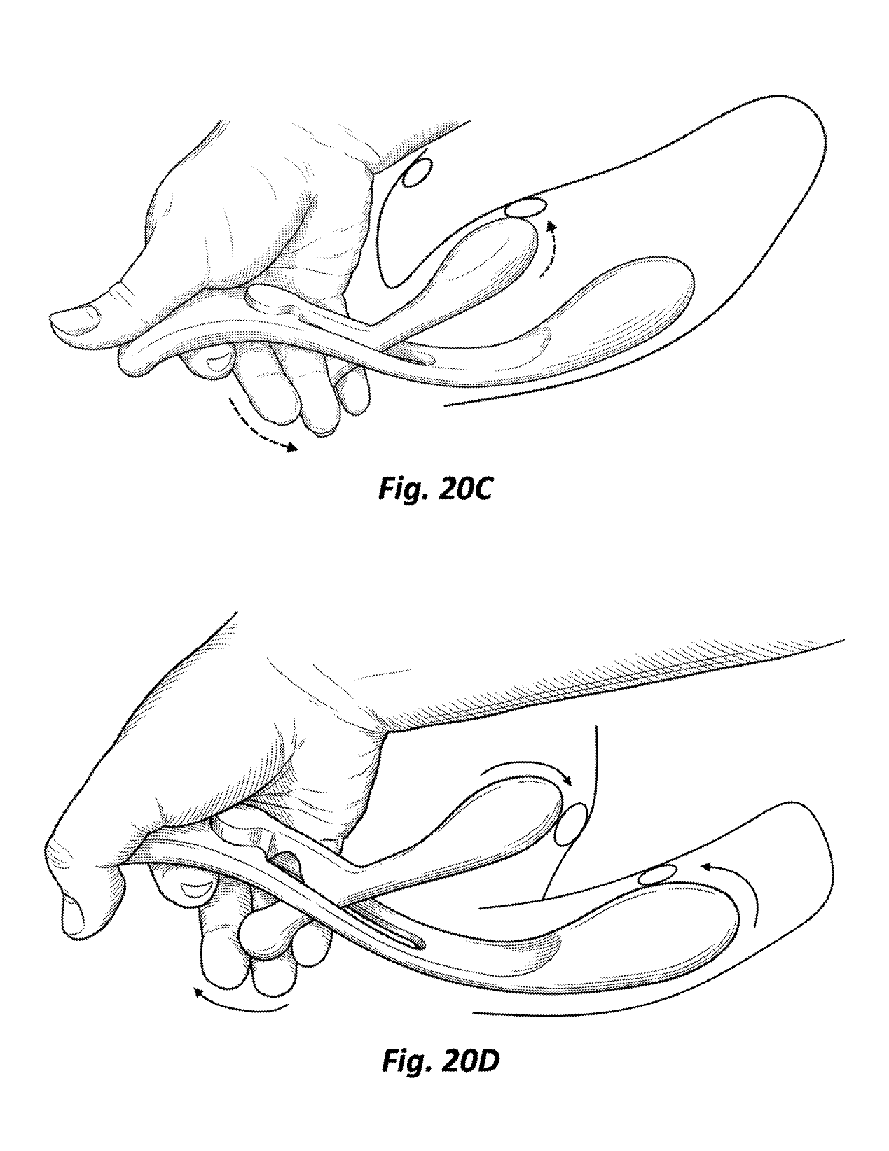

FIGS. 20A through 20D illustrate the exemplary disclosed sexual stimulation device transitioning between different configurations (e.g., different “continuous deformation paths”). For example as opposed to referring to a translational trajectory or insertion path of a stimulating member into a body orifice, the exemplary disclosed “path” may refer to a deformation tendency and/or direction of the exemplary disclosed main body (e.g., main body 1010, main body 2010, and main body 3010) as it transitions between different configurations. For example as illustrated in FIGS. 20A through 20D, this deformation tendency and directional progression are schematically represented by arrows indicating how the main body moves or deforms when the hand-held portion is actuated in at least some exemplary embodiments. Accordingly for example, “path” may be understood as a configuration-transition path defined by structural deformation of the exemplary disclosed main body, rather than a spatial movement trajectory of an end portion for example into a body orifice. The exemplary disclosed deformation path may include relative rotation, bending, elastic recovery, and/or any other suitable structural transformations of the exemplary disclosed main body. The exemplary disclosed deformation path may be defined by a mechanical relationship between the exemplary disclosed first stimulating member and the exemplary disclosed second stimulating member, for example as controlled by a user using the exemplary disclosed hand-held portion.

In at least some exemplary embodiments, the continuous deformation path is bidirectional and reversible. The continuous deformation path may include a forward deformation direction and a reverse deformation direction. The forward deformation direction may correspond to a user applying a manual force to the hand-held portion in a direction aligned with a structural deformation tendency of the main body, thereby causing the main body to progressively deform from one configuration toward another configuration along the continuous deformation path. The reverse deformation direction may correspond to the user reducing, releasing, or applying an opposite manual force to the hand-held portion, thereby causing the main body to return along substantially the same structural deformation relationship.

The arrows illustrated in FIGS. 20A-20D schematically represent both forward and reverse deformation directions along the continuous deformation path. Solid arrows may indicate a forward deformation direction, while dashed arrows may indicate a reverse deformation direction. These arrows represent a configuration-transition tendency defined by structural deformation of the main body, rather than a spatial insertion trajectory of a stimulating member into a body orifice.

The continuous deformation path may be continuous in the sense that intermediate configurations exist between the illustrated configurations of FIGS. 20A-20D. In at least some exemplary embodiments, the transition between configurations does not involve discrete locking positions. Instead, the main body may assume a plurality of intermediate configurations as the user performs a gesture operation on the hand-held portion. Each gesture operation may correspond to a directional traversal of the continuous deformation path, and different gesture operations may correspond to different directional traversals between the first range, second range, third range, and fourth range of configurations described herein.

In at least some exemplary embodiments, a gesture operation described herein may include at least one of (i) a finger-opening operation and (ii) a finger-closing operation performed by the user while holding the hand-held portion. Different gesture operations may correspond to different directional traversals of the continuous deformation path between different ranges of configurations, and the same type of finger operation (e.g., finger-opening or finger-closing) may correspond to different gesture operations in different embodiments depending on the manner and direction of force applied to the hand-held portion.

For example as illustrated in FIG. 20A, the exemplary disclosed main body may be continuously deformable in response to a first gesture operation performed by a user on the exemplary disclosed hand-held portion, such that the first gesture operation causes the main body to transition from a configuration within a first range of the plurality of configurations along a continuous deformation path to a configuration within a second range of the plurality of configurations (e.g., as illustrated in FIG. 20B) along the continuous deformation path. In the first range of the configurations along the continuous deformation path, the first stimulating member and the second stimulating end may be both adapted to be inserted into or out of the same orifice of the human body, for example as illustrated in FIG. 20A.

In at least some exemplary embodiments, the first gesture operation that causes the main body to transition from a configuration within the first range to a configuration within the second range along the continuous deformation path may comprise a finger-opening operation performed by the user while holding the hand-held portion. In such embodiments, the finger-opening operation may apply a manual force to the hand-held portion in a forward deformation direction corresponding to the structural deformation tendency of the main body, thereby causing the main body to traverse the continuous deformation path from the first range of configurations to the second range of configurations.

Also for example as illustrated in FIG. 20B, in the second range of the configurations along the exemplary disclosed continuous deformation path, the exemplary disclosed first stimulating member may be adapted to be inserted into or out of the orifice while the exemplary disclosed second stimulating end portion of the second stimulating member may be adapted to remain outside the orifice and in continuous contact with a first erogenous region adjacent the orifice.

Further for example, the exemplary disclosed main body may be further continuously deformable in response to a second gesture operation performed by a user on the exemplary disclosed hand-held portion, such that the second gesture operation causes the main body to transition from a configuration within the first range of the configurations (e.g., as illustrated in FIG. 20A) along a continuous deformation path to a configuration within a third range of the configurations along the continuous deformation path as illustrated in FIG. 20C. In the third range of the configurations along the continuous deformation path, the exemplary disclosed first stimulating member and the exemplary disclosed second stimulating end may both be positioned within the orifice of the human body, and wherein the second stimulating end portion may be urged toward and presses against a second erogenous region within the orifice of the human body for example as illustrated in FIG. 20C.

Further for example, the exemplary disclosed main body may be further continuously deformable in response to a third gesture operation performed by the user on the exemplary disclosed hand-held portion, such that the third gesture operation causes the exemplary disclosed main body to transition from a configuration within the second range of the configurations (e.g., as illustrated in FIG. 20B) along the continuous deformation path to a configuration within a fourth range of the configurations along the continuous deformation path for example as illustrated in FIG. 20D. In the fourth range of the configurations along the continuous deformation path for example as illustrated in FIG. 20D, the exemplary disclosed first stimulating member may be positioned within the orifice of the human body and may be urged toward a sexually sensitive region within the orifice of the human body, and the exemplary disclosed second stimulating member may be positioned outside the orifice and may be urged toward a sexually sensitive region adjacent the orifice of the human body. In doing so and for example as illustrated in FIG. 20D, the sexually sensitive region within the orifice of the human body may be compressed between the exemplary disclosed first stimulating member and the exemplary disclosed second stimulating member.

In at least some exemplary embodiments, the second gesture operation and/or the third gesture operation may comprise a finger-closing operation performed by the user while holding the hand-held portion. In such embodiments, the finger-closing operation may apply a manual force to the hand-held portion in a direction corresponding to a structural deformation tendency of the main body, thereby causing the main body to transition along the continuous deformation path from the first range of configurations to the third range of configurations, and/or from the second range of configurations to the fourth range of configurations. In some embodiments, the finger-closing operation may correspond to a directional traversal of the continuous deformation path different from that of the finger-opening operation.

Various exemplary embodiments of the exemplary disclosed sexual stimulation device are described above regarding sexual stimulation devices 1000, 2000, 3000, and 4000. The various features of sexual stimulation devices 1000, 2000, 3000, and/or 4000 may be suitably combined together so that a given embodiment may have features of at least some or substantially all of sexual stimulation devices 1000, 2000, 3000, and/or 4000.

The exemplary disclosed system, apparatus, and method may be used in any suitable application for providing sexual stimulation. The exemplary disclosed system, apparatus, and method may be used in any suitable application for providing a sexual stimulation device such as a sexual toy (e.g., an adult toy). For example, the exemplary disclosed system, apparatus, and method may be used in any suitable application for providing a vibrator such as a combination vibrator.

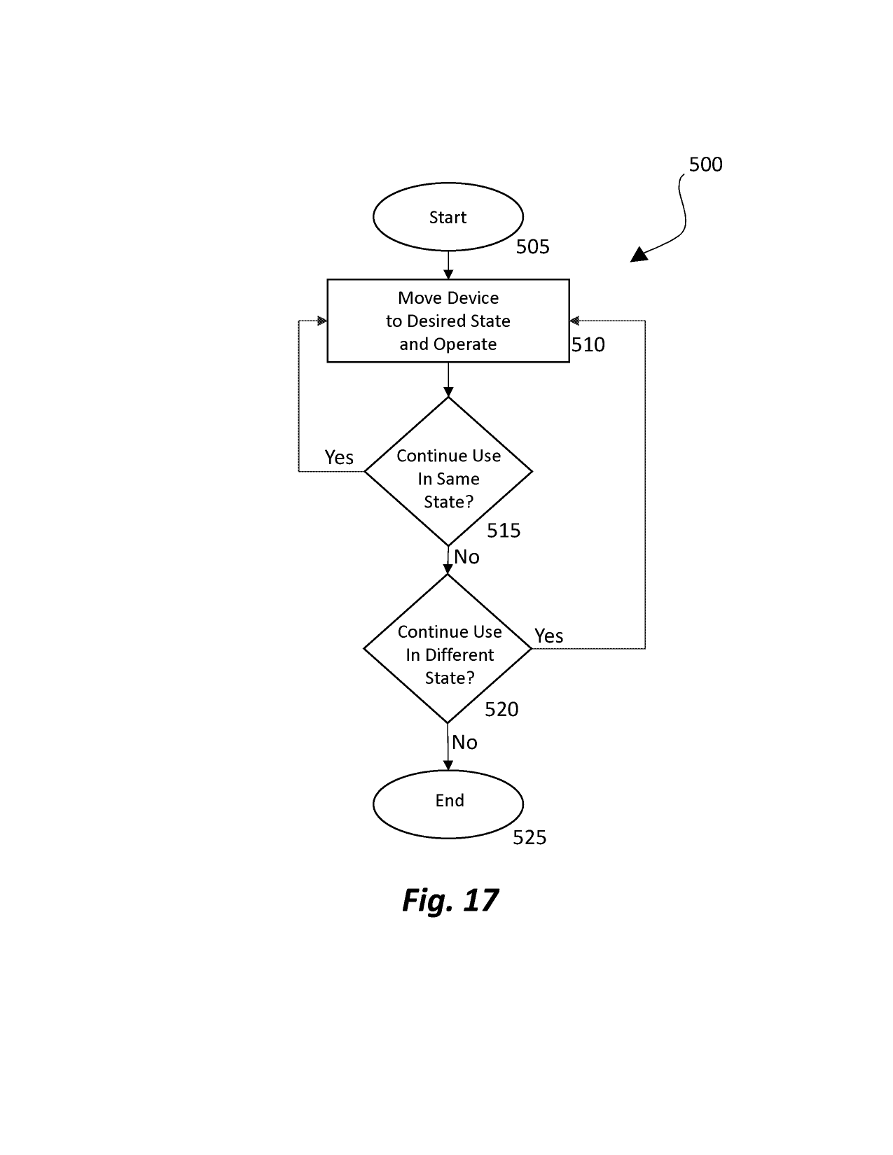

FIG. 17 illustrates an exemplary process for a use or operation of the exemplary disclosed sexual stimulation device (e.g., sexual stimulation device 1000, 2000, 3000, or 4000). Process 500 begins at step 505. At step 510, a user may manipulate the exemplary disclosed sexual stimulation device (e.g., sexual stimulation device 1000, 2000, 3000, or 4000) and move the exemplary disclosed sexual stimulation device to a desired state (e.g., the exemplary disclosed initial state, compressed state, or expanded state for example as described above). If the user wishes to use the exemplary disclosed sexual stimulation device in an initial state (e.g., as illustrated in FIG. 6 or FIG. 15) that may be an at rest or default state, then the exemplary disclosed stimulating members may not be moved prior to use because the exemplary disclosed stimulating members may already be in the at rest or default state as described above. If the user wishes to use the exemplary disclosed sexual stimulation device in a state other than the initial state, then the user may move the exemplary disclosed stimulating members to the desired state for example as described above (e.g., the exemplary disclosed compressed state for example as illustrated in FIGS. 8 and 16, or the exemplary disclosed expanded state for example as illustrated in FIGS. 10 and 14).

At step 515, the user may determine whether to continue operation of the exemplary disclosed sexual stimulation device in the same state as currently used in step 510. If the user wishes to continue use in the same state, process 500 returns to step 510, at which the user may continue operation in the same state. As many iterations as desired of steps 510 and 515 may be performed. If the user does not wish to continue use in the same state, process 500 proceeds to step 520.

At step 520, the user may determine whether to continue operation of the exemplary disclosed sexual stimulation device in a different state. If the user wishes to use the exemplary disclosed sexual stimulation device in a different state, process 500 returns to step 510. At step 510, the user may change a state of the exemplary disclosed sexual stimulation device as described above and then continue to use the exemplary disclosed sexual stimulation device in the new state as described above. As many iterations as desired of steps 510 through 520 may be performed. If the user does not wish to continue use in a different state, process 500 ends at step 525.

In at least some exemplary embodiments, the exemplary disclosed sexual stimulation device may include a main body (e.g., the exemplary disclosed main body of sexual stimulation device 1000, 2000, 3000, or 4000) having one or more configurations (e.g., configurations or shapes) including an initial configuration. The main body may include a first stimulating member configured to be inserted into an orifice of a human body (e.g., as illustrated in FIGS. 18A and/or 18B), and a second stimulating member having a second stimulating end configured to be inserted into the orifice of the human body or to contact a sensitive region on an outer surface of the human body (e.g., as illustrated in FIGS. 18A and/or 18B). The main body may also include a hand-held portion configured such that, when the first stimulating member moves into or out of the orifice of the human body, the configuration of the main body changes in response to at least one type of a gesture operation performed by a user on the hand-held portion (e.g., the user manipulating the exemplary disclosed hand-held portion for example as described above). The main body has a first configuration in which, when the sexual stimulation device is manually driven, the first stimulating member and the second stimulating end are configured to move into or out of the same orifice of the human body (e.g., as illustrated in FIG. 18A). The main body may have a second configuration in which the second stimulating end is maintained outside the orifice of the human body, and when the sexual stimulation device is manually driven, the first stimulating member is configured to move into or out of the orifice of the human body while the second stimulating end remains in continuous contact with the sensitive region on the outer surface of the human body (e.g., as illustrated in FIG. 18B).

In at least some exemplary embodiments (e.g., as illustrated in FIGS. 14 through 16), the hand-held portion may include one or more pressing sections configured to be actuated by a user through a finger-closing operation and/or a finger-opening operation. Such finger operations may constitute gesture operations performed by the user while holding the hand-held portion. When the user actuates the pressing sections (e.g., by bringing them closer together or moving them farther apart), the main body may be urged to deform and traverse the continuous deformation path illustrated in FIGS. 20A through 20D in a selected direction. The specific transition effected by a finger-closing operation and/or a finger-opening operation may depend on, for example, the direction of manual force applied to the hand-held portion and the current configuration or current range of configurations of the main body. For example, in at least some embodiments, a finger-opening operation may correspond to a first gesture operation that causes the main body to transition from a configuration within a first range of configurations (e.g., as illustrated in FIG. 20A) to a configuration within a second range of configurations (e.g., as illustrated in FIG. 20B). In at least some embodiments, a finger-closing operation may correspond to at least one of a second gesture operation and a third gesture operation that causes the main body to transition to a configuration within a third range of configurations (e.g., as illustrated in FIG. 20C) and/or to a configuration within a fourth range of configurations (e.g., as illustrated in FIG. 20D). Accordingly, the gesture operation may be understood as a user-controlled actuation of the hand-held portion that induces structural deformation of the main body along the continuous deformation path, rather than as a simple switching between discrete and independent states. The continuous deformation path may therefore include forward and reverse directional traversals driven by controlled finger-opening and/or finger-closing operations in combination with the structural relationship between the first stimulating member and the second stimulating member.

In at least some exemplary embodiments, the second stimulating member may be configured to intersect with the first stimulating member so as to allow relative rotation between the first and second stimulating members in accordance with the change of the configuration of the main body (e.g., as described above regarding the exemplary disclosed crossing arrangement for example as illustrated in FIGS. 6 through 13). The exemplary disclosed main body together with the hand-held portion may be defined by an elongated rod (e.g., elongated member such as an elongated rod as described above) having at least one curved portion to form the first and second stimulating members, and wherein the second stimulating member may extend from a first side of the main body across or beyond the main body itself to a second side of the main body, such that a distance is maintained between a first stimulating end of the first stimulating member and the second stimulating end (e.g., as illustrated in FIGS. 6 through 13). The main body includes at least one through-hole (e.g., through-hole 1020 or through-hole 3020), extending therethrough, and the second stimulating end is configured to pass from the first side of the main body through the at least one through-hole and extend to the second side of the main body. The second stimulating end may be configured to pass from the first side of the main body through a through-hole (e.g., through-hole 1020 or through-hole 3020) of the main body and extend to the second side of the main body, and then pass through another through-hole from the second side to the first side and remain on the first side. The main body may topologically define a unique through-hole (e.g., through-hole 1020 or through-hole 3020) extending therethrough, and the second stimulating end being configured to pass from the first side of the main body through the unique through-hole and extend to and remain on the second side of the main body. For example, the through-hole may be topologically defined based on the through-hole remaining substantially unchanged (e.g., in size and/or dimensions) under deformation of the main body such as continuous deformation (e.g., stretching or bending for example as the main body moves between the exemplary disclosed states such as the initial state, the compressed state, and/or the expanded state.

In at least some exemplary embodiments, the exemplary disclosed sexual stimulation device may include a fastener (e.g., fastener 4500) such as an elastic pivot joint configured to rotatably couple the first stimulating member and the second stimulating member to each other. The hand-held portion may further include a first pressing section of the first stimulating member and a second pressing section of the second stimulating member configured to cause the configuration of the main body to change based on a gripping operation by the user on the hand-held portion.

In at least some exemplary embodiments, the exemplary disclosed sexual stimulation device may include an actuator having at least a portion embedded in a first stimulating end of the first stimulating member and/or the second stimulating end (e.g., as described above regarding actuator 1010a and/or actuator 1010b), the actuator being configured to provide at least one type of stimulation selected from patting, pressing, vibrating, oscillating, rotating, reciprocating, swinging, waving, heating, cooling, and micro-current stimulation. The exemplary disclosed sexual stimulation device may further include a control module (e.g., the exemplary disclosed control module described above) having a plurality of buttons, wherein one of the plurality of buttons may be configured to cause the actuator to operate at a maximum output power.

The invention includes other illustrative embodiments (“Embodiments”) as follows.

Embodiment 1: A sexual stimulation device, comprising: a main body having a plurality of configurations; and a hand-held portion; wherein the main body includes: a first stimulating member, adapted to be inserted into an orifice of a human body; and a second stimulating member having a second stimulating end; wherein the main body is continuously deformable in response to a first gesture operation performed by a user on the hand-held portion, such that the first gesture operation causes the main body to transition from a first configuration within a first range of the plurality of configurations along a continuous deformation path to a second configuration within a second range of the plurality of configurations along the continuous deformation path; wherein, in the first range of the plurality of configurations along the continuous deformation path, the first stimulating member and the second stimulating end are both adapted to be inserted into or out of the orifice, which is the same orifice, of the human body; and wherein, in the second range of the plurality of configurations along the continuous deformation path, the first stimulating member is adapted to be inserted into or out of the orifice while the second stimulating end is adapted to remain outside of the orifice and in continuous contact with a first erogenous region adjacent to the orifice.

Embodiment 2: The sexual stimulation device of Embodiment 1, wherein the main body is further continuously deformable in response to a second gesture operation performed by the user on the hand-held portion, such that the second gesture operation causes the main body to transition from the first configuration within the first range of the plurality of configurations along the continuous deformation path to a third configuration within a third range of the plurality of configurations along the continuous deformation path.

Embodiment 3: The sexual stimulation device of Embodiment 2, wherein, in the third range of the plurality of configurations along the continuous deformation path, the first stimulating member and the second stimulating end are both positioned within the orifice of the human body, and wherein the second stimulating end is urged toward and presses against a second erogenous region within the orifice of the human body.

Embodiment 4: The sexual stimulation device of Embodiment 1, wherein the main body is further continuously deformable in response to a third gesture operation performed by the user on the hand-held portion, such that the third gesture operation causes the main body to transition from a second configuration within the second range of the plurality of configurations along the continuous deformation path to a fourth configuration within a fourth range of the plurality of configurations along the continuous deformation path.

Embodiment 5: The sexual stimulation device of Embodiment 4, wherein, in the fourth range of the plurality of configurations along the continuous deformation path, the first stimulating member is positioned within the orifice of the human body and is urged toward a first sexually sensitive region within the orifice of the human body, and the second stimulating member is positioned outside of the orifice and is urged toward a second sexually sensitive region adjacent to the orifice of the human body, such that the first sexually sensitive region within the orifice of the human body is compressed between the first stimulating member and the second stimulating member.

Embodiment 6: The sexual stimulation device of Embodiment 1, wherein each of the first gesture operation, the second gesture operation, and the third gesture operation includes at least one of a finger-closing operation and a finger-opening operation performed by the user while holding the hand-held portion.

Embodiment 7: The sexual stimulation device of Embodiment 6, wherein the finger-opening operation corresponds to the first gesture operation that causes the main body to transition from the first configuration within the first range of the plurality of configurations to the second configuration within the second range of the plurality of configurations.

Embodiment 7A: The sexual stimulation device of Embodiment 6, wherein a first gesture operation causes the main body to transition from a configuration within the first range of configurations to a configuration within the second range of configurations along the continuous deformation path in a forward deformation direction.

Embodiment 7B: The sexual stimulation device of Embodiment 6, wherein a second gesture operation, different from the first gesture operation, causes the main body to transition from a configuration within the second range of configurations to a configuration within the first range of configurations along the continuous deformation path in a reverse deformation direction.

Embodiment 7C: The sexual stimulation device of Embodiment 6, wherein the main body includes an elastic connector configured to provide an elastic restoring force that establishes the structural deformation tendency of the main body along the continuous deformation path, and wherein the gesture operation applies a manual force to the hand-held portion in a direction aligned with the elastic restoring force.

Embodiment 8: The sexual stimulation device of Embodiment 6, wherein the finger-closing operation corresponds to at least one of the second gesture operation and the third gesture operation that causes the main body to transition to the third configuration within the third range of the plurality of configurations or the fourth configuration within the fourth range of the plurality of configurations.

Embodiment 9: The sexual stimulation device of Embodiment 4, wherein the third gesture operation includes a finger-opening operation performed by the user while holding the hand-held portion.

Embodiment 10: The sexual stimulation device of Embodiment 1, wherein the main body includes an elongated rod having at least one curved portion that forms the first stimulating member and the second stimulating member, and wherein the second stimulating member extends from a first side of the main body to a second side of the main body across or beyond the main body such that a distance is maintained between a first stimulating end of the first stimulating member and the second stimulating end.

Embodiment 11: The sexual stimulation device of Embodiment 10, wherein the hand-held portion is integrally formed with the elongated rod and constitutes a portion of the elongated rod between the first stimulating member and the second stimulating member.

Embodiment 12: The sexual stimulation device of Embodiment 10, wherein the second stimulating end is configured to pass from the first side of the main body through a first through-hole formed in the main body to the second side of the main body, and then pass through a second through-hole formed in the main body from the second side back to the first side and remain on the first side.

Embodiment 13: The sexual stimulation device of Embodiment 1, wherein the second stimulating member is configured to intersect with the first stimulating member so as to allow relative rotation between the first stimulating member and the second stimulating member in accordance with a transition of the main body between different configurations.

Embodiment 14: The sexual stimulation device of Embodiment 13, wherein the second stimulating member extends through a through-hole formed in the first stimulating member so as to intersect the first stimulating member.

Embodiment 15: The sexual stimulation device of Embodiment 13, wherein the first stimulating member and the second stimulating member are elastically coupled to each other by an elastic connector that allows relative rotational movement between the first stimulating member and the second stimulating member while maintaining the intersecting relationship between the first stimulating member and the second stimulating member.

Embodiment 16: The sexual stimulation device of Embodiment 14, wherein the through-hole formed in the first stimulating member is an elongated hole extending along an axial direction of the first stimulating member.

Embodiment 17: The sexual stimulation device of Embodiment 15, wherein the elastic connector is configured to be elastically stretchable such that, in addition to the relative rotational movement, the first stimulating member and the second stimulating member are further movable relative to each other along an axial direction of the first stimulating member while remaining intersected.

Embodiment 18: The sexual stimulation device of Embodiment 1, further comprising at least one actuator disposed at least partially within at least one of a first stimulating end of the first stimulating member and the second stimulating end, the at least one actuator being configured to provide at least one type of stimulation selected from the group consisting of patting, pressing, vibrating, oscillating, rotating, reciprocating, swinging, waving, heating, cooling, micro-current stimulation, and combinations thereof.

Embodiment 19: A method, comprising: operating a sexual stimulation device including a main body and a hand-held portion, the main body including a first stimulating member and a second stimulating member having a second stimulating end; and performing a gesture operation on the hand-held portion to continuously deform the main body along a continuous deformation path, such that the main body transitions between different configurations along the continuous deformation path; wherein, in a first range of the configurations along the continuous deformation path, the method further comprises inserting both the first stimulating member and the second stimulating end into or out of an orifice, which is the same orifice, of a human body; wherein, in a second range of the configurations along the continuous deformation path, the method further comprises inserting the first stimulating member into or out of the orifice while maintaining the second stimulating end outside of the orifice and in continuous contact with a first erogenous region adjacent to the orifice; and wherein the transition between the first range and the second range is effected by the gesture operation being performed on the hand-held portion while the first stimulating member moves into or out of the orifice.

Embodiment 20: The method of Embodiment 19, further comprising: performing a further gesture operation to transition the main body from the first range of the configurations to a third range of the configurations along the continuous deformation path; and in the third range of the configurations, positioning both the first stimulating member and the second stimulating end within the orifice and urging the second stimulating end toward and against a second erogenous region within the orifice of the human body.

Embodiment 21: The method of Embodiment 19, further comprising performing a further gesture operation to transition the main body from the second range of the configurations to a fourth range of the configurations along the continuous deformation path; and in the fourth range of the configurations, positioning the first stimulating member within the orifice and urging the first stimulating member toward a first sexually sensitive region within the orifice, while positioning the second stimulating end outside the orifice and urging the second stimulating end toward a second sexually sensitive region adjacent to the orifice, such that the sexually sensitive region within the orifice is compressed between the first stimulating member and the second stimulating member.

The exemplary disclosed system, apparatus, and method may provide an efficient and effective technique for relatively easy adjustment and manipulation of a sexual stimulation device. For example, the exemplary disclosed system, apparatus, and method may provide a combination vibrator providing multiple distinct forms of stimulation involving relatively easy adjustment and manipulation. Further for example, the exemplary disclosed system, apparatus, and method may provide an efficient and effective technique for a user, during insertion or withdrawal of a sexual stimulation device into or out from a body orifice (e.g., a vagina or anal), to directly switch a configuration of a sexual stimulation device using simple one-handed gesture operations.

In at least some exemplary embodiments, the exemplary disclosed system, apparatus, and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

The exemplary disclosed system may include an agentic AI system. The agentic AI system may include sensors for example as described herein (e.g., cameras, microphones, and other exemplary disclosed sensors of male accessory 308, female accessory 315, male user device 305 and/or female user device 310, including for example respective sensor array 306, imaging device 350, and/or any other suitable devices described herein). The agentic AI system may also include input channels for processing raw data obtained by system 300 and a data preprocessing module for preparing data for use by the exemplary disclosed engines. The agentic AI system may utilize algorithms for analyzing the obtained data for example as described herein. The agentic AI system may operate (e.g., using reinforcement learning or rule-based planning) to create a series of activities or actions for achieving a desired result. The agentic AI system may then organize stored data for use in reasoning and decision-making by the system. The agentic AI system may implement activities and results as physical actions (e.g., of the exemplary disclosed adult toys) and/or software commands (e.g., of the exemplary disclosed component described herein). The agentic AI system may utilize output channels such as the exemplary disclosed applications and/or control of the exemplary disclosed adult toys. The agentic AI system may also utilize feedback loops using the exemplary disclosed components to monitor and evaluate results of its actions and feedback (e.g., based on comments and actions of users using the exemplary disclosed devices including for example tipping and other user behavior). The agentic AI system may utilize any suitable machine learning operations such as supervised learning (e.g., involving labeling data and focusing on performance of specific tasks), reinforcement learning (e.g., involving rewards and penalties received on a trial and error basis), transfer learning (e.g., use of knowledge obtained on previous tasks for use on future tasks), and/or unsupervised learning (e.g., system 300 detecting relationships and patterns without the use of data labeling).

An illustrative representation of a computing device appropriate for use with embodiments of the system of the present disclosure is shown in FIG. 21. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 22, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system, apparatus, and method provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 22, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 22, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine that may be a networked configuration provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on – any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system, apparatus, and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A sexual stimulation device, comprising:
a main body having a plurality of configurations; and
a hand-held portion;
wherein the main body includes:
a first stimulating member, adapted to be inserted into an orifice of a human body; and
a second stimulating member having a second stimulating end;
wherein the main body is continuously deformable in response to a first gesture operation performed by a user on the hand-held portion, such that the first gesture operation causes the main body to transition from a first configuration within a first range of the plurality of configurations along a continuous deformation path to a second configuration within a second range of the plurality of configurations along the continuous deformation path;
wherein, in the first range of the plurality of configurations along the continuous deformation path, the first stimulating member and the second stimulating end are both adapted to be inserted into or out of the orifice, which is the same orifice, of the human body; and
wherein, in the second range of the plurality of configurations along the continuous deformation path, the first stimulating member is adapted to be inserted into or out of the orifice while the second stimulating end is adapted to remain outside of the orifice and in continuous contact with a first erogenous region adjacent to the orifice.

2. The sexual stimulation device of claim 1, wherein the main body is further continuously deformable in response to a second gesture operation performed by the user on the hand-held portion, such that the second gesture operation causes the main body to transition from the first configuration within the first range of the plurality of configurations along the continuous deformation path to a third configuration within a third range of the plurality of configurations along the continuous deformation path.

3. The sexual stimulation device of claim 2, wherein, in the third range of the plurality of configurations along the continuous deformation path, the first stimulating member and the second stimulating end are both positioned within the orifice of the human body, and wherein the second stimulating end is urged toward and presses against a second erogenous region within the orifice of the human body.

4. The sexual stimulation device of claim 1, wherein the main body is further continuously deformable in response to a third gesture operation performed by the user on the hand-held portion, such that the third gesture operation causes the main body to transition from a second configuration within the second range of the plurality of configurations along the continuous deformation path to a fourth configuration within a fourth range of the plurality of configurations along the continuous deformation path.

5. The sexual stimulation device of claim 4, wherein, in the fourth range of the plurality of configurations along the continuous deformation path, the first stimulating member is positioned within the orifice of the human body and is urged toward a first sexually sensitive region within the orifice of the human body, and the second stimulating member is positioned outside of the orifice and is urged toward a second sexually sensitive region adjacent to the orifice of the human body, such that the first sexually sensitive region within the orifice of the human body is compressed between the first stimulating member and the second stimulating member.

6. The sexual stimulation device of claim 1, wherein each of the first gesture operation, the second gesture operation, and the third gesture operation includes at least one of a finger-closing operation and a finger-opening operation performed by the user while holding the hand-held portion.

7. The sexual stimulation device of claim 6, wherein the first gesture operation causes the main body to transition from a configuration within the first range of configurations to a configuration within the second range of configurations along the continuous deformation path in a forward deformation direction.

8. The sexual stimulation device of claim 6, wherein the second gesture operation, different from the first gesture operation, causes the main body to transition from a configuration within the second range of configurations to a configuration within the first range of configurations along the continuous deformation path in a reverse deformation direction.

9. The sexual stimulation device of claim 6, wherein the main body includes an elastic connector configured to provide an elastic restoring force that establishes the structural deformation tendency of the main body along the continuous deformation path, and wherein the gesture operation applies a manual force to the hand-held portion in a direction aligned with the elastic restoring force.

10. The sexual stimulation device of claim 6, wherein the finger-opening operation corresponds to the first gesture operation that causes the main body to transition from the first configuration within the first range of the plurality of configurations to the second configuration within the second range of the plurality of configurations.

11. The sexual stimulation device of claim 6, wherein the finger-closing operation corresponds to at least one of the second gesture operation and the third gesture operation that causes the main body to transition to the third configuration within the third range of the plurality of configurations or the fourth configuration within the fourth range of the plurality of configurations.

12. The sexual stimulation device of claim 4, wherein the third gesture operation includes a finger-opening operation performed by the user while holding the hand-held portion.

13. The sexual stimulation device of claim 1, wherein the main body includes an elongated rod having at least one curved portion that forms the first stimulating member and the second stimulating member, and wherein the second stimulating member extends from a first side of the main body to a second side of the main body across or beyond the main body such that a distance is maintained between a first stimulating end of the first stimulating member and the second stimulating end.

14. The sexual stimulation device of claim 13, wherein the hand-held portion is integrally formed with the elongated rod and constitutes a portion of the elongated rod between the first stimulating member and the second stimulating member.

15. The sexual stimulation device of claim 13, wherein the second stimulating end is configured to pass from the first side of the main body through a first through-hole formed in the main body to the second side of the main body, and then pass through a second through-hole formed in the main body from the second side back to the first side and remain on the first side.

16. The sexual stimulation device of claim 1, wherein the second stimulating member is configured to intersect with the first stimulating member so as to allow relative rotation between the first stimulating member and the second stimulating member in accordance with a transition of the main body between different configurations.

17. The sexual stimulation device of claim 16, wherein the second stimulating member extends through a through-hole formed in the first stimulating member so as to intersect the first stimulating member.

18. The sexual stimulation device of claim 16, wherein the first stimulating member and the second stimulating member are elastically coupled to each other by an elastic connector that allows relative rotational movement between the first stimulating member and the second stimulating member while maintaining the intersecting relationship between the first stimulating member and the second stimulating member.

19. The sexual stimulation device of claim 17, wherein the through-hole formed in the first stimulating member is an elongated hole extending along an axial direction of the first stimulating member.

20. The sexual stimulation device of claim 18, wherein the elastic connector is configured to be elastically stretchable such that, in addition to the relative rotational movement, the first stimulating member and the second stimulating member are further movable relative to each other along an axial direction of the first stimulating member while remaining intersected.

21. The sexual stimulation device of claim 1, further comprising at least one actuator disposed at least partially within at least one of a first stimulating end of the first stimulating member and the second stimulating end, the at least one actuator being configured to provide at least one type of stimulation selected from the group consisting of patting, pressing, vibrating, oscillating, rotating, reciprocating, swinging, waving, heating, cooling, micro-current stimulation, and combinations thereof.

22. A method, comprising:
operating a sexual stimulation device including a main body and a hand-held portion, the main body including a first stimulating member and a second stimulating member having a second stimulating end; and
performing a gesture operation on the hand-held portion to continuously deform the main body along a continuous deformation path, such that the main body transitions between different configurations along the continuous deformation path;
wherein, in a first range of the configurations along the continuous deformation path, the method further comprises inserting both the first stimulating member and the second stimulating end into or out of an orifice, which is the same orifice, of a human body;
wherein, in a second range of the configurations along the continuous deformation path, the method further comprises inserting the first stimulating member into or out of the orifice while maintaining the second stimulating end outside of the orifice and in continuous contact with a first erogenous region adjacent to the orifice; and
wherein the transition between the first range and the second range is effected by the gesture operation being performed on the hand-held portion while the first stimulating member moves into or out of the orifice.

23. The method of claim 22, further comprising: performing a further gesture operation to transition the main body from the first range of the configurations to a third range of the configurations along the continuous deformation path; and in the third range of the configurations, positioning both the first stimulating member and the second stimulating end within the orifice and urging the second stimulating end toward and against a second erogenous region within the orifice of the human body.

24. The method of claim 22, further comprising performing a further gesture operation to transition the main body from the second range of the configurations to a fourth range of the configurations along the continuous deformation path; and in the fourth range of the configurations, positioning the first stimulating member within the orifice and urging the first stimulating member toward a first sexually sensitive region within the orifice, while positioning the second stimulating end outside the orifice and urging the second stimulating end toward a second sexually sensitive region adjacent to the orifice, such that the sexually sensitive region within the orifice is compressed between the first stimulating member and the second stimulating member.
